(19) United States
(12) Patent Application Publication
(10) Pub. No.: US 2024/0400387 A1
(43) Pub. Date: Dec. 5, 2024

(54) Systems and Methods for Producing Syngas and Derivatives

(71) Applicant: Carbogenesis LLC, Miami, FL (US)

(72) Inventors: David S. SOANE, Coral Gables, FL (US); Alexander V. SOANE, Coral Gables, FL (US); Sudheer Kumar JAWLA, Miami, FL (US); Nathan Stuart CORBIN, Miami, FL (US); Joseph Edward SCHWAN, Miami, FL (US)

(21) Appl. No.: 18/645,062

(22) Filed: Apr. 24, 2024

Related U.S. Application Data
(60) Provisional application No. 63/565,999, filed on Mar. 15, 2024.
(60) Provisional application No. 63/610,613, filed on Dec. 15, 2023.
(60) Provisional application No. 63/599,221, filed on Nov. 15, 2023.
(60) Provisional application No. 63/522,539, filed on Jun. 22, 2023.
(60) Provisional application No. 63/466,404, filed on May 15, 2023.
(60) Provisional application No. 63/461,704, filed on Apr. 25, 2023.

(51) Int. Cl. C01B 3/34

(52) U.S. Cl. CPC C01B 3/342; C01B 2203/0238; C01B 2203/062; C01B 2203/0855; C01B 2203/0861; C01B 2203/0866; C01B 2203/1241; C01B 2203/1247; C01B 2203/142; C01B 2203/148; C01B 2203/82

(57) ABSTRACT

The invention includes a systems and methods for producing a gaseous outflow stream comprising chemical products and thermal energy, where the method includes providing a first reactant stream comprising CO2 and a second reactant stream comprising a hydrocarbon reactant, providing a plasma reactor equipped with a source of microwave energy for forming a non-thermal plasma; mixing the first reactant stream and the second reactant stream to form a feedgas mixture; directing the feedgas mixture to encounter microwave energy in the plasma reactor, wherein the microwave energy energizes the feedgas mixture to form the non-thermal plasma, thereby producing thermal energy and transforming the feedgas mixture in the non-thermal plasma into a product mixture comprising the chemical products; and directing the product mixture and the thermal energy to exit the plasma reactor, thereby forming the gaseous outflow stream comprising the chemical products and the thermal energy.

### RELATED APPLICATIONS

This application claims the benefit of U.S. Provisional Application No. 63/461,704 filed Apr. 25, 2023, U.S. Provisional Application No. 63/466,404 filed May 15, 2023, U.S. Provisional Application No. 63/522,539 filed Jun. 22, 2023, U.S. Provisional Application No. 63/599,221 filed Nov. 15, 2023, U.S. Provisional Application No. 63/610,613 filed Dec. 15, 2023, and U.S. Provisional Application No. 63/565,599 filed Mar. 15, 2024. The entire contents of the above applications are incorporated by reference herein.

### FIELD OF THE APPLICATION

This application relates to systems and methods for producing syngas and products derived therefrom.

### BACKGROUND

Syngas is recognized as an important precursor substance for the formation of industrially important chemical products. Its two components, hydrogen and carbon monoxide, each have a variety of uses.

Syngas, already containing hydrogen, can be used to produce even more hydrogen by reacting the carbon monoxide in the syngas with steam to produce additional hydrogen plus carbon dioxide, in a reaction known as the water-gas shift reaction as shown in EQ1:

$$CO + {H}_{2} O ↔ {CO}_{2} + {H}_{2} \qquad EQ1$$

Although this reaction produces CO₂, an undesirable greenhouse gas, it can be used for production of hydrogen that can be used as an environmentally advantageous fuel.

The carbon monoxide in syngas serves as an important feedstock that can be transformed into a wide range of commodity chemicals, such as (without limitation) acrylic acid, formic acid, dimethyl carbonate, acetic acid, acetic anhydride, propionic acid, and the like, and derivatives thereof. In addition, syngas itself can be used as feedstock for various industrial processes, such as Fischer-Tropsch (F-T) synthesis, ammonia synthesis, substitute natural gas synthesis, direct dimethyl ether synthesis, methanol synthesis, and the like.

As an example, the F-T process, typically carried out catalytically, converts the carbon monoxide and hydrogen in the syngas into hydrocarbons of various molecular weights, as shown in EQ2:

$$( 2 n + 1 ) {H}_{2} + nnCO \to {C}_{n} {H}_{( 2 n + 2 )} + n {H}_{2} O \\ ( where n is an integer ) \qquad EQ2$$

The F-T process conditions can be chosen to maximize formation of higher molecular weight hydrocarbons of higher value, such as liquid fuels. Depending on the reaction conditions, it can be used to produce hydrocarbons ranging from methane to higher molecular weight paraffins and olefins. Small amounts of lower molecular weight oxygenates such as alcohol and organic acid can also be formed, due in part to the competing water-gas-shift reaction taking place at the same time.

As another example, syngas can be used to produce methanol, which in turn can be used to form myriad of other chemicals of industrial significance. Methanol production for 2022 was estimated to reach over 111 million metric tons, increasing 4% as compared to 2021. Methanol is produced from syngas via a well-established synthetic process as shown in EQ3, enjoying single-pass conversion ranging from 50-80%, with methanol selectivity over 99%:

$$CO ( g ) + 2 {H}_{2} ( g ) 〈 -- 〉 {CH}_{3} OH ( g ) \qquad EQ3$$

Syngas assumes even more importance in contemporary chemistry because it can be produced by the reaction of two key greenhouse gases, CH₄ and CO₂, thus capturing these two gases and converting them into other valuable products with less environmental impact. One method of syngas production, termed dry reforming or dry reforming of methane (DRM), uses both CH₄ and CO₂ as feedstock, producing syngas according to the following EQ4:

$${CO}_{2} + {CH}_{4} \to 2 {H}_{2} + 2 CO \qquad EQ4$$

In the conventional dry reforming process, methane reacts with the carbon dioxide to produce syngas at temperatures between 700° C. and 900° C., although higher temperatures can be used. Dry reforming is highly endothermic (ΔH298K°=+247.4 KJ/mol): to carry out dry reforming using conventional techniques, considerable energy must be supplied to the reaction, leading to high operating costs. Conventional dry reforming also requires catalysts. Traditional catalyzed reactions rely on surface adsorption of chemical species for a targeted bond to be activated, i.e., for it to be stretched/weakened sufficiently to allow formation of alternate bonds with the co-reactant (which itself must also be adsorbed on the catalytic bed in spatial adjacency); thus, catalytic reactions are inherently a 2-D process limited by the total available catalytic surface area and affinity for adsorption. Catalysts are also notoriously prone to poisoning by impurities such as sulfur compounds, and to deactivation in the presence of carbonaceous materials such as soot. In addition, conventional dry reforming is plagued by side reactions such as reverse water gas shift, methanation, methane decomposition, reverse of carbon gasification, and the Boudouard reaction. These side reactions that occur during conventional dry reforming reduce the yield of syngas, affect the ratio of carbon monoxide and hydrogen in the final syngas product, and contribute to the formation of elemental carbon that is deposited within the system and that can deactivate the catalyst. Dry reforming, because it consumes both CO₂ and CH₄ to produce syngas, appears to offer significant environmental benefits. However, its drawbacks have prevented it from gaining widespread industrial implementation as a method for producing syngas.

Thus, the dry reforming process for forming syngas has only recently begun to achieve commercial traction. Previously, alternative conventional technologies such as steam reforming, partial oxidation, and autothermal reforming dominated the production of syngas. Each of these legacy alternative technologies uses a hydrocarbon (e.g., methane) as the feedstock and oxidizes it to produce carbon monoxide and hydrogen. However, none of these alternatives provides for the capture and utilization of two carbon-containing greenhouse gases, methane and CO₂, that take place in dry reforming. In fact, under certain circumstances, these legacy technologies can produce more environmentally undesirable CO₂, instead of drawing down the amount of CO₂ that already exists in the environment.

Recognizing the importance of removing greenhouse gases from the atmosphere, it would be advantageous to produce syngas using techniques that optimize carbon capture and utilization. Advantageously, syngas would be formed without adding more carbon dioxide to the atmosphere, and without requiring large amounts of input energy. Advantageously, a commercially viable process for forming syngas could use greenhouse gases for feedstock, thus removing these substances from the atmosphere while producing a desirable product. For example, it would be desirable to use the abundant methane and carbon dioxide feedstock sources that presently exist to convert them into syngas and other useful derivatives.

The challenges to using methane and carbon dioxide to form syngas through the conventional processes of dry reforming have been daunting, however. As mentioned above, dry reforming requires considerable energy input and produces large amounts of elemental carbon in the form of coke that can impair the catalysts required to carry out the reactions. As mentioned above, catalytic methods have their own limitations as well; catalysts are costly and easily contaminated and inactivated. There remains a need in the art, therefore, for optimized, non-catalytic processes for making syngas that maximize the potential of the dry reforming equation (EQ4) for carbon capture and utilization by using two greenhouse gases as feedstock: CO₂ and CH₄.

Such a system can take advantage of the abundance of these feedstock sources, forming higher value products while removing these greenhouse gases from the environment. There is a further need in the art for a process that forms syngas without imposing the burdens on the environment that occur with existing technologies.

Moreover, there is a need in the art for processes that make dry reforming of methane (DRM) economically attractive, so that such a technique can be used more generally as a mechanism for carbon capture. Various uses for the components of syngas exist already; it would be advantageous to seamlessly match the output of a DRM-based syngas-forming process with other industrial chemical procedures, so that the chemical components of syngas (CO and H₂) can be incorporated in higher-value products. Expanding the repertoire of secondary products yielded by a DRM-based syngas-producing system can increase the rate of economic return for such a system, increasing the commercial incentives for industries to adopt this approach for utilizing these two carbon-containing greenhouse gases, methane and CO₂.

### SUMMARY OF THE INVENTION

Disclosed herein, in embodiments, are methods for producing a gaseous outflow stream comprising chemical products and thermal energy, comprising providing a first reactant stream comprising CO₂ and a second reactant stream comprising a hydrocarbon reactant; providing a plasma reactor equipped with a source of microwave energy for forming a non-thermal plasma; mixing the first reactant stream and the second reactant stream to form a feedgas mixture; directing the feedgas mixture to encounter microwave energy in the plasma reactor, wherein the microwave energy energizes the feedgas mixture to form the non-thermal plasma, thereby producing thermal energy and transforming the feedgas mixture in the non-thermal plasma into a product mixture comprising the chemical products; and directing the product mixture and the thermal energy to exit the plasma reactor, thereby forming the gaseous outflow stream comprising the chemical products and the thermal energy.

In embodiments, the chemical products comprise CO and H₂. In embodiments, the feedgas mixture further comprises an auxiliary reactant, which can be hydrogen. In embodiments, the hydrocarbon reactant comprises CH₄, or consists essentially of CH₄. In embodiments, the hydrocarbon reactant is derived from a biogas. In embodiments, the step of mixing the first reactant stream and the second reactant stream to form the feedgas mixture takes place outside the plasma reactor prior to the step of directing the feedgas mixture to encounter the microwave energy in the plasma reactor. In embodiments, the step of mixing the first reactant stream and the second reactant stream to form the feedgas mixture takes place within the plasma reactor prior to the step of directing the feedgas mixture to encounter the microwave energy in the plasma reactor. In embodiments, the method further comprises the step of flowing the gaseous outflow stream through an outflow tract in fluid communication with the plasma reactor, wherein the outflow tract comprises a shape-forming structure. In embodiments, the method further comprises the step of directing the outflow mixture to exit the plasma reactor comprises flowing the outflow mixture through an outflow tract, wherein the outflow tract comprises a shape-forming structure. The shape-forming structure can comprise a jet-producing nozzle, which can be a converging-diverging nozzle.

Further disclosed herein are methods of producing one or more derivative products, comprising forming a gaseous outflow stream by the methods described above; flowing the gaseous outflow mixture (also referred to herein as “outflow stream”) through an outflow tract in fluid communication with the plasma reactor to enter a derivative reaction zone; and producing a derivative reaction in the derivative reaction zone using the chemical products, or the thermal energy, or a combination thereof, to form the one or more derivative products. In embodiments, the step of producing the derivative reaction further comprises adding additive particles to the gaseous outflow stream. In embodiments, the step of producing the derivative reaction comprises adding additive particles to the gaseous outflow stream; in embodiments, the additive particles are non-carbon particles, and the derivative reaction forms composite particles. In embodiments, the derivative reaction is produced using the chemical products, which can comprise carbon solids. Such carbon solids can provide seeds for formation or further growth of the carbon solids. In embodiments, the method wherein the derivative reaction is produced by directing a secondary reactant to enter the derivative reaction zone to react therein with the chemical products.

In other embodiments, the derivative reaction is produced using the thermal energy by directing a reaction target to enter the derivative reaction zone to react therein with the thermal energy, without involving the chemical products in the derivative reaction. In embodiments, the reaction target can be a hydrocarbon reactant. In embodiments, the derivative reaction is a pyrolysis reaction. In embodiments, the hydrocarbon reactant can be selected from the group consisting of methane, ethane, propane, ethylene, and acetylene, for example, ethane. In embodiments, the hydrocarbon reactant is a mixture of a first hydrocarbon gas and a second hydrocarbon gas, which can be selected from the group consisting of methane, ethane, propane, ethylene, and acetylene. In embodiments, the reaction target comprises a natural polymer derived from biomass, which can be lignin or hemicellulose. In embodiments, the natural polymer derived from biomass can be pyrolyzed to produce biochar, which can be further processed to produce activated carbon. In embodiments, the reaction target can comprise a synthetic hydrocarbon-derived polymer or a fluorinated molecule, or the reaction target can comprise one or more petroleum residua materials, which can comprise bitumen. In embodiments, the one or more petroleum residua materials are derived from crude oil bottoms or waste oil. In embodiments, the derivative reaction is produced using the thermal energy, and can form one or more derivative products, which can comprise carbon solids. In certain embodiments, the method further comprises a step of isolating the reaction target from the chemical products prior to the step of producing the derivative reaction. For example, the reaction target can be sequestered within a self-contained heating chamber within a thermal mediator subsystem within the derivative reaction zone, wherein the reaction target is isolated from the chemical products, and wherein the reaction target is exposed to the thermal energy, thereby producing the derivative reaction.

In yet further embodiments, the one or more derivative products produced by the methods described herein comprise a plurality of different derivative products, which can be refined or otherwise processed to produce a selected product mix. For example, the selected product mix can form a sustainable aviation fuel.

Further disclosed herein are methods for producing a gaseous outflow stream comprising energized additive particles, chemical products and thermal energy, comprising: providing a first reactant stream comprising CO₂ and a second reactant stream comprising a hydrocarbon reactant; providing a plasma reactor equipped with a source of microwave energy for forming a non-thermal plasma; mixing the first reactant stream and the second reactant stream with a population of additive particles to form a complex feedgas; directing the complex feedgas to encounter microwave energy in the plasma reactor, wherein the microwave energy energizes the complex feedgas to form a complex plasma comprising the energized additive particles, the chemical products, and the thermal energy; and directing the complex plasma to exit the plasma reactor, thereby forming the gaseous outflow stream comprising the energized additive particles, the chemical products and the thermal energy. In the aforesaid method, the chemical products can comprise CO and H₂.

Also disclosed herein are methods of producing a derivative reaction, comprising forming a gaseous outflow stream by the methods described in the paragraph above; directing the energized additive particles to enter a secondary reaction zone; and producing a derivative reaction therein using the energized additive particles. In embodiments, the energized additive particles are carbon particles and the derivative reaction forms carbon solids. In embodiments, the energized additive particles are non-carbon particles, and the derivative reaction forms composite particles. In embodiments, the derivative reaction is produced using the chemical products; the chemical products can comprise carbon solids, which can provide seeds for formation or further growth of carbon solids.

Also disclosed herein are methods of producing a tertiary reaction, comprising producing the one or more derivative products as described above and processing the one or more derivative products to react with each other or to react with a tertiary reactant, thereby producing the tertiary reaction, which can yield a polymer.

Disclosed herein, in embodiments, are plasma-based systems for converting a feedgas mixture comprising a hydrocarbon reactant and CO₂ into a gaseous outflow stream comprising chemical products and thermal energy, the system comprising: a source of the hydrocarbon reactant and a source of the CO₂ wherein the source of the hydrocarbon reactant provides the hydrocarbon for the feedgas mixture and the source of the CO₂ provides the CO₂ for the feedgas mixture; a plasma reactor having a proximal end and a distal end and a plasma reaction zone therebetween, wherein the plasma reactor is in fluid communication with the source of the hydrocarbon reactant and the source of the CO₂, and wherein the feedgas mixture is directed to follow an injection path within the plasma reactor from the source of the hydrocarbon reactant and the source of the CO₂, thereby reaching the plasma reaction zone; a source of microwave energy, wherein the source delivers the microwave energy to the plasma reaction zone to produce a non-thermal plasma from the feedgas mixture therein, thereby converting the feedgas mixture into the chemical products, and thereby producing the thermal energy, and an outflow tract at the distal end of the reaction zone and in fluid communication therewith, wherein the chemical products and the thermal energy exit the reaction zone to enter the outflow tract to be removed from the plasma reactor.

Also disclosed herein are plasma-based systems for converting a hydrocarbon reactant and CO₂ into a gaseous outflow stream comprising chemical products and thermal energy, the system comprising: a feedgas subsystem delivering the hydrocarbon reactant and the CO₂ into a plasma reactor, wherein the plasma reactor has a proximal end and a distal end and a plasma reaction zone therebetween, wherein the hydrocarbon reactant and the CO₂ are directed to follow a flow path to enter the plasma reactor and to pass therethrough, and wherein the hydrocarbon reactant and the CO₂ enter the plasma reaction zone in a mixed state; a source of microwave energy, wherein the source delivers the microwave energy to the plasma reaction zone as the hydrocarbon reactant and the CO₂ pass therethrough in the mixed state, to produce a non-thermal plasma from the mixed state of the hydrocarbon reactant and the CO₂, and wherein the non-thermal plasma converts the hydrocarbon reactant and the CO₂ into the chemical products and further produces the thermal energy; and an outflow tract at the distal end of the reaction chamber and in fluid communication therewith, wherein the chemical products and the thermal energy exit the reaction zone as a gaseous outflow stream that enters the outflow tract to be removed from the plasma reactor. In embodiments, one or both of the hydrocarbon reactant and the CO₂ enter the plasma reactor at the proximal end and pass through the plasma reaction zone from proximal to distal as an antegrade flow that follows a unidirectional flow path; in embodiments, the antegrade flow comprises one or more vortical flows. In embodiments, one or both of the hydrocarbon reactant and the CO₂ enter the plasma reactor at the distal end and flow peripherally as a retrograde flow through the plasma reactor from distal to proximal, with a reversal of flow at the proximal end, to pass through the plasma reaction zone centrally from proximal to distal as an antegrade flow, wherein the antegrade flow and the retrograde flow together form a bidirectional flow path. In embodiments, at least one of the retrograde flow and the antegrade flow comprises one or more vortical flows. In embodiments, the reversal of flow at the proximal end is produced by the encounter of one or both of the hydrocarbon reactant and the CO₂ with a top barrier that redirects and reverses the flow, which top barrier can be shaped as an inverted dome. In embodiments, the system further comprises a mixing mechanism wherein the hydrocarbon reactant and the CO₂ are mixed prior to entering the plasma reactor. In embodiments, the mixing mechanism can be positioned outside the plasma reactor and the feedgas enters the plasma reactor in the mixed state; in other embodiments, the mixing mechanism can be positioned inside the plasma reactor and the hydrocarbon reactant and the CO₂ are mixed within the plasma reactor to form the feedgas mixture. In embodiments, the outflow tract comprises a shape-forming structure, which can be a jet-producing nozzle, such as a convergent-divergent nozzle.

Further disclosed herein, in embodiments, are modular systems for converting a hydrocarbon reactant and CO₂ into a gaseous outflow stream comprising chemical products and thermal energy, wherein the modular system comprises one or more of the plasma-based systems as described above operatively connected with a control system, wherein the control system controls at least one functional parameter of the one or more plasma-based systems. In embodiments, the modular system comprises a single plasma-based system and the control system. In embodiments, the modular system is adapted for temporary installation, and it can be adapted for conveyance in or on a transportation vehicle. In embodiments, the modular system is skid-mounted; such a system can comprise a microwave assembly comprising 1) the magnetron and waveguides for generating plasma in a plasma reactor; 2) the plasma reactor assembly; 3) a water-cooling system, including chiller; 4) various controls, pumps, and connections for gas inflow and product outflow. In embodiments, the functional parameter described above is selected from the group consisting of feedgas components, inflow velocity, inflow flow rate, pressure within the one or more plasma-based systems, and on/off status for the one or more plasma-based systems. In embodiments wherein the functional parameter is on/off status for the one or more plasma-based systems, the control system can monitor availability of power or the price point for power for the one or more plasma-based systems, and controls the off/on status for the one or more plasma-based systems based on at least one of the availability and the price point.

Also disclosed herein are systems for producing a derivative reaction, comprising the system described above, in combination with a derivative reaction zone in fluid communication with the outflow tract, wherein the shape-forming structure directs one or more components of the product mixture into the derivative reaction zone; and an injector for delivering one or more external reactants into the outflow tract or into the derivative reaction zone, wherein an interaction between external reactants and at least one of the chemical products and the thermal energy produces the derivative reaction. In embodiments, the derivative reaction is a heat-focused derivative reaction, and the external reactants are reaction targets. In embodiments, the system further comprises a separation mechanism to isolate the reaction targets from the one or more chemical products. In other embodiments, the derivative reaction is a chemical-focused reaction and the external reactant is a secondary reactant. In embodiments, the injector further delivers a population of additive particles into the system. In embodiments, the injector is an additive injector, wherein the additive injector is positioned to introduce a population of additive particles into the system at an insertion point, wherein the insertion point is located within the outflow tract or within the secondary reaction zone.

### BRIEF DESCRIPTION OF THE FIGURES

FIG. 1 depicts a block diagram of a plasma-based system for converting CH₄ and CO₂ into syngas.

FIG. 2 is a schematic drawing showing a flow path of gases within a plasma reactor.

FIG. 3 is a schematic drawing showing a flow path of gases within a plasma reactor.

FIG. 4 is a schematic representation of an idealized lignin structure.

FIG. 5 is a schematic representation of two pathways for producing sustainable aviation fuel (SAF) using a plasma-based system for converting CH₄ and CO₂ into syngas.

FIGS. 6A and 6B are transmission electron microscopy and electron diffraction micrographs showing the structure of nanoparticles.

FIG. 7 depicts schematically in longitudinal cross-section a portion of an embodiment of a reaction system.

FIGS. 8A-C are transmission electron micrographs showing synthesized carbon nanomaterials.

FIG. 9 depicts schematically in longitudinal cross-section a portion of an embodiment of a reaction system.

FIG. 10A depicts schematically in longitudinal cross-section an embodiment of a reaction system. FIG. 10B depicts a source of secondary reactants.

FIG. 11 depicts schematically in longitudinal cross-section an embodiment of a reaction system.

FIG. 12 depicts schematically in longitudinal cross-section an embodiment of a reaction system.

FIG. 13 is a block diagram of a reaction system for heat-focused derivative reactions.

FIG. 14 combines a CAD simulation (Section A) with a schematic illustration (Section B) to depict an embodiment of a reaction system.

FIG. 15A depicts schematically in longitudinal cross-section an embodiment of a reaction system. FIG. 15B provides a close-up view of the thermal mediator subsystem of the reaction system that is depicted in FIG. 15A.

### DETAILED DESCRIPTION

Disclosed herein, in embodiments, are plasma-based systems and methods for converting a feedgas mixture comprising two primary reactants, a hydrocarbon (e.g., CH₄) and CO₂, into syngas. As used herein, the term “primary reactant” refer to those reactants that are energized to produce the plasma state described below. The primary reactants involved in the present systems and methods are a hydrocarbon (e.g., methane) and CO₂. As used herein, the term “syngas” or “syngas mixture” refers to a gaseous mixture of hydrogen and carbon monoxide, containing, in embodiments, about 30-60% hydrogen, about 25-30% carbon monoxide, 0-5% methane, and about 5-15% carbon dioxide. In embodiments, syngas can contain other gas components, for example inert gases such as nitrogen present in amounts up to 40%, and can further contain H₂O in amounts up to about 10%.

In embodiments, these systems and methods use microwave energy to form the plasma from the primary reactants in the feedgas mixture. In an embodiment, the primary reactants in the feedstock, methane and carbon dioxide, are both resistant to chemical conversion because of their stability: the bond dissociation energy of methane is 439 KJ/mol, and about 532 KJ/mol is required to split CO₂ into its components carbon monoxide and oxygen. Using the techniques described below, the plasma can be employed to break the bonds in these molecules, allowing their recombination so that carbon monoxide and hydrogen molecules can be formed from these feedgases with high efficiency and selectivity, and combined to yield syngas. Further disclosed herein are methods for utilizing the syngas to produce derivative products, and methods for using the thermal energy emanating from the plasma reactor to power other chemical reactions.

The plasma generated according to these systems and methods is a gas phase plasma, formed from gaseous reactants to produce gaseous products. Within the plasma, collisions between the charged species and uncharged species transfer energy, creating a highly reactive chemical environment that allows desired chemical reactions to proceed rapidly and efficiently. Because of the high degree of ionization of the precursor gas, the chemical dissociation and ionization of intermediates, and the elevated vibrational and excitational energies in the plasma, the desired chemical reactions described below proceed rapidly and efficiently. The plasma thus produced can be characterized as a non-thermal plasma. While plasma temperatures in the range of 1500K or lower can achieve the desired conversion of CO₂ and CH₄ into CO and H₂ (in accordance with the DRM equation EQ4), the plasma formed in the reactor as disclosed herein is able to attain a higher temperature than what is usually associated with a non-thermal plasma, with some measurements obtained as high as about 5000K. However, higher temperatures within the plasma can be associated with more tendency to produce carbon solids instead of desired products, leading to fouling of the reactor and poor product yield. The factors leading to carbon solid formation thus require management, as described in more detail below.

Central to the systems and methods for producing syngas as disclosed herein is the reactor for forming the microwave-induced plasma. Certain features of these reaction systems and their utilization for producing syngas are described below. While the systems and methods disclosed herein focus on the operation of a single reactor and related subsystems, it is understood that such reaction systems are also suitable for combining as modules in a multiplexed array. In more detail, and without limitation, such multiplexing can include an arrangement of two or more of the inventive reaction systems, in arrays such as two, three, four, eight, sixteen, or other numbers of modules. The multiplexed array further comprises a control system, allowing centralized control of one or more functional parameters of the individual reaction systems, such as feedgas components, inflow velocity or flow rate, pressure within the system, on/off status, and the like.

The individual reactor system modules can be fabricated compactly, and can be customized in size based on customer needs. The modules are suitable for fixed installation or for temporary, adjustable installation. The reactor system modules can be skid-mounted individually or as modules in a larger modular system, and/or they can be adapted for conveyance in or on a transportation vehicle such as a tractor trailer or a flatbed for portable use at appropriate facilities. A skid-mounted system can have, for example, an assembly with four major parts: 1) a microwave assembly comprising the magnetron and waveguides for generating the plasma in the plasma reactor; 2) the plasma reactor assembly; 3) the water-cooling system, including chiller; 4) the various controls, pumps, and connections for gas inflow and product outflow; and (5) other subsystems as required by intended uses (for example, subsystems as described below for producing derivative reactions in Stage 2). Other arrangements and arrays of the inventive reaction systems individually or as components of modular array as envisioned by the disclosures herein can be implemented by skilled artisans using no more than routine experimentation.

### 1. Plasma Generation and Management

Plasma is an ionized gas that is created by applying enough energy to a feedstock material to create a significant density of electrons and ions within it. Besides containing the charged species, a plasma also contains uncharged neutral species and unaffected reactants that are available for other chemical reactions. Plasma is characterized as a separate state of matter, having some ordinary properties of gases but also having properties, such as responding to electric and magnetic fields while being electrically neutral, that are due to the charged species that it contains.

The plasma used in these systems and methods is formed from two primary feedgases, CO₂ and a hydrocarbon (e.g., CH₄), which act as primary reactants. As described below, other substances can be added as auxiliary reactants; however, even in the presence of auxiliary reactants, the decomposition of the primary feedgases in the plasma and their subsequent recombination are the drivers for the formation of the syngas products.

Plasmas are able to generate temperatures much higher than those produced by conventional chemical engineering processes. While characterized as a non-thermal plasma, the plasma produced used for these systems and methods can result in higher temperatures than typical non-thermal plasmas. As is understood by those of skill in the art, the term “non-thermal plasma” as used herein refers to a high-temperature non-equilibrium plasma, which is capable of generating very high bulk-gas temperatures, such as are described below in more detail. Not to be bound by theory, it is understood that this can reflect the involvement of the very stable reactant molecules CO₂ and CH₄ (or another hydrocarbon) in producing the plasma: since these are both extremely stable molecules, their breakdown in the plasma is energy-demanding, which can cause the plasma gas to exhibit ultra-high operating temperatures. In embodiments, high plasma temperatures (5000K and above) have been achieved in the reactor, producing significant amounts of thermal energy that can be exploited for other uses, as described below.

In embodiments, microwaves are used to form the plasma, with microwave energy being directed at the feedgas mixture in the reactor. Without being bound by theory, microwave radiation is understood to act as follows to create a plasma. When the feedgas mixture of the hydrocarbon (e.g., CH₄) and CO₂ is subjected to microwave radiation that meets or exceeds the dielectric strength of the gas components, the free electrons present in the microwave field region become sufficiently energized that they can ionize other atoms or molecule. These reactions, termed “primary reactions,” take place within a vessel, such as a hollow cylindrical tube, termed a “plasma reaction chamber.” The region within the plasma reaction chamber where these reactions take place can be termed the “plasma reaction zone.” Secondary electrons derived from these ionized atoms or molecules are then accelerated through the electrical field until they collide with other atoms or molecules to cause other ionization events. This process of ionization progresses throughout the microwave field region until a steady state is reached. The final number of electrons in the plasma is determined mainly by the electron loss processes of the plasma, such as diffusion, recombination, and attachment. The action of electrons in the plasma colliding with other charged and uncharged species leads to the rupture of existing covalent bonds in the reactant species, with the formation of radicals that can then combine or recombine to form reaction products. Generation of the plasma itself can take place by mechanisms familiar in the art. In an embodiment, the plasma can be initiated by a spark from a tungsten tip, while in other embodiments no initiation is required.

The systems and methods disclosed herein can be managed with a high degree of precision by altering the composition and flow of the feedgases and by controlling the conditions for plasma generation. These variables are readily changed to achieve desired results, including the formation of reaction products in the plasma and the elimination of undesired byproducts. Moreover, the system itself can be adjusted to respond to and take advantage of external factors such as feedgas availability, feedgas composition, and energy input.

In an embodiment, the system can be adjusted for “just-in-time” responsiveness, so that the plasma is generated only when a certain feedgas becomes available; in embodiments, the system can be adjusted to operate only at particular times of the day when an appropriate amount of energy is available. For example, the microwave plasma reactor and the system overall can be turned off or on instantly to synchronize its energy utilization with local availability, thus allowing the system to take advantage of local marginal pricing for electricity. Similarly, the system can be programmed to operate during peak power availability and reduced grid demand, making it ideally suited for use with intermittent energy sources such as wind and solar, or for use with electric grids to smooth out supply-demand mismatch. This feature makes the system as disclosed herein especially advantageous for installations where low-cost power availability waxes and wanes and where CO₂ can be temporarily stored: the ability to turn the system off and on or to control the rate or volume of plasma-driven reactions allows for dynamic utilization of the stored CO₂ in a cost-effective manner. The responsiveness of a single system or a multiplexed array to energy fluctuations can be controlled by a control system operatively connected with a single system or a multiplexed array thereof to control the functional parameters of individual reaction systems, as described above. The control system can further monitor availability of power from power sources and/or its price points, to regulate the controlled functional parameters, including controlling the off/on status of one or more reactors based on parameters such as the availability of power and the price point, with the control system controlling either single reactors or reactors arranged in a multiplexed array (e.g., turning such reactors on or off at certain times to take advantage of energy supplies and optimal economics). This controllable responsiveness of the microwave-generated plasma and related subsystems contrasts sharply with the adjustability of traditional industrial chemistry systems that are driven by heat and pressure.

The formation of reaction products in the plasma (termed “primary reaction products”) is determined by the shifted chemical equilibria within it, which can be influenced by factors involved in plasma formation and propagation such as (without limitation) the composition of the reactant feedgas, the flow dynamics of the reactants entering into and passing through the reactor, the temperature and pressures in the reaction system, the amount and power of microwave energy creating the plasma, the energy density in the reaction zone, the geometry of the reactor itself, the presence of other electrical or magnetic fields, and the like. These various functional parameters can be managed to select for certain desirable reaction products. In embodiments, the formation of undesirable products (such as soot and other carbonaceous byproducts produced by plasma-excited reactions) can be suppressed by managing factors in the plasma involved in plasma formation and plasma propagation. Desirably, ambient or near-ambient pressures can be used within the system, rather than requiring subambient pressure. For the production of syngas, the production of CO and H₂ is selectively desired, but certain ratios of CO to H₂ within the syngas product can be further selected for and achieved. For example, in embodiments, an excess of H₂ in the product mixture is desirable so that it can be recycled (as described in more detail below) or otherwise separated for commercialization. As used herein, the term “recycled” refers to a gas stream that is an effluent from the reactor, optionally separated into various component gases, in which some or all of the gas stream or component gases are reintroduced into the reaction chamber as one or more reactants. In some embodiments, the hydrogen in the product mixture can be separated from other effluents and is reintroduced as a reactant in a purified form. In other embodiments, the recycled gas can include hydrogen and other effluent components produced during the plasma reaction, such as carbon monoxide, more complex hydrocarbons, and the like. The recycled gas can also comprise an additional auxiliary reactant such as nitrogen if nitrogen is present in the reactor's gaseous outflow stream.

### 2. Feedgas Composition and Reaction Optimization

a. Stage 1 Primary Reactants

The primary reactants for forming syngas in the plasma-based system disclosed herein include carbon dioxide and a hydrocarbon. In a preferred embodiment, methane and carbon dioxide are combined as the primary reactants to be energized in the plasma. The set of reactions involving these primary reactants and any auxiliary reactants or additives (as described below) are termed “primary reactions” or “Stage 1 reactions.” Stage 1 reactions using methane and CO₂ as primary reactants produce syngas in a reaction that is shown at a high level in the equation EQ4 for dry reforming shown above. However, the reaction pathways occurring in the plasma are considerably more complicated than those in the conventional DRM chemical reaction because the former involves the interaction of a multitude of ionized and neutral species in the plasma.

In order to decrease and manage the number of concomitant reactions in the plasma, the single-carbon reactant methane can be selected as the primary hydrocarbon reactant to combine with CO₂. While methane is a preferred hydrocarbon reactant, other hydrocarbon molecules can be used instead or in addition, recognizing that as the carbon count in the hydrocarbon reactant molecule increases, the product mixture becomes even more complex due to the availability of more potential synthons resulting from plasma energization. Therefore, even though other hydrocarbon reactants can be used in a plasma reaction with carbon dioxide to produce syngas, it is advantageous to use the single-carbon reactant methane as a primary reactant in conjunction with carbon dioxide. Using methane to react with carbon dioxide has the additional advantage of employing two greenhouse gases (CH₄ and CO₂) as reactants, thus capturing them and converting them into a useful product, syngas.

A primary reactant such as methane can be provided as an unmixed gas feed to combine with CO₂ to generate the plasma, or it can be provided as a component of a mixed gas source. Natural gas and biogas are examples of mixed gas sources comprising methane that are suitable for use as feedstocks. Such mixed gases can also comprise higher hydrocarbons in varying amounts along with methane, depending on their sources. Biogas typically already contains CO₂; its use as a feedgas reduces the need for importing CO₂ from other sources to feed into the system.

In embodiments, a variety of mixed industrial gases can be used as feedgas sources to provide (a) the primary hydrocarbon reactant to combine with CO₂ to generate a plasma, (b) the CO₂ to combine with primary hydrocarbon reactants from other sources; or (c) both. Exemplary feedgas sources include emissions from landfills, power plants, steel mills, ethanol fermenters, refineries, and organic waste streams such as biogas. Certain of these streams contain significant amounts of CO₂, and can contain hydrocarbons such as methane. Advantageously, any gas mixture with significant amount of either CO₂ or hydrocarbons (e.g., methane, ethane, propane, or higher hydrocarbons) can be used, including gas mixtures that contain H₂O. Under certain circumstances, described below in more detail, it is advantageous to include H₂O as an auxiliary feedgas, for example because it can increase the amount of H₂ made relative to the CO in the syngas. The plasma process described herein can also tolerate certain gas impurities in the feedgas source which do not require removal, such as H₂, CO, O₂, and Ar. O₂ that is present in the feedgas source is reactive in the plasma, but it will combine with hydrocarbons in the reactor to contribute to the yield of syngas. However, if O₂ is present in noticeable amounts (about >1%), it can be measured and factored into pre-mixing calculations to produce the desired balance of syngas components. N₂ in the mixed feedgas source is mostly unreactive, but can form small amounts of HCN that can be removed downstream by conventional methods. Sulfur impurities (e.g., H2S) can be removed by pretreatment using conventional methods.

The ratio of H₂ to CO in the final syngas output of the plasma reactor depends on the atomic ratios of these elements being fed into the process. The composition of mixed feedgas sources may need to be modified and “tuned” to achieve the desired final syngas composition. Such tuning can be achieved by mixing the mixed feedgas source gas with other feed streams that have been enriched with CO₂, hydrocarbon(s), and/or H₂O. Such additional feed streams can come from various sources, including direct air capture (for CO₂), boiler steam (for H₂O), industrial pipelines (for CO₂, and hydrocarbons such as CH₄), or imported gas tanks (for CO₂, hydrocarbons). Heaters can be used to preheat the feedgas to a desirable temperature, or to maintain a feedgas in a gaseous state. A composition analyzer, familiar to skilled artisans in the field (e.g., gas chromatograph, mass spectrometer, and the like) can be used on the mixed feedgas before or after any additions or pretreatments to determine which further modifications would be needed (e.g., adding feedgas components to optimize the mix, or determining the amount of extra feedgas components would be needed). Mixing mechanisms can be carried out using standard equipment (flow controllers, pumps, pipes, and the like) familiar to skilled artisans in the field.

b. Stage 1 Auxiliary Reactants and Additives

Advantageously, other reactants, termed “auxiliary reactants,” can be introduced into the reactor along with the primary reactants, methane (or other hydrocarbons) and CO₂. As used herein, the term “auxiliary reactant” includes nitrogen, oxygen, carbon monoxide, hydrogen and water, as well as inert gases such as the noble gases (e.g., argon, helium, neon, krypton, and xenon). Desirably, an auxiliary reactant can be added to improve the conditions for forming the primary reaction products, or to mitigate carbon deposition or to control gas flow and temperature, although it is recognized that using a particular auxiliary reactant can also have drawbacks. For example, oxygen can be added as an auxiliary reactant, as it is known to oxidize and volatize away carbonaceous solids. However, it also has the strong tendency to combine with any produced hydrogen to yield water, thus significantly reducing hydrogen yield and decreasing the overall energy efficiency for producing the desired reaction, the conversion of CO₂ and methane (or other hydrocarbon) into syngas.

As another example, adding water as an auxiliary reactant can assist with suppressing the deposition of soot and carbonaceous films. However, water is a highly stable molecule thermodynamically, the energization of which consumes a large amount of energy. Thus, while adding water has advantages, it lowers the overall energy efficiency of the reactions for forming syngas. But water has further advantages for producing syngas, in particular controlling the ratio of H₂ to CO in the final syngas product. Water is advantageous for this purpose because it is a cheap, safe, and potentially sustainable source of additional H₂. By controlling the water-to-CO₂ ratio, the H₂-to-CO ratio can be increased from 1:1 for purely dry reforming to 2:1 suitable for methanol production, as shown in EQ5:

$$3 {CH}_{4} + 2 {H}_{2} O + {CO}_{2} \to 4 CO + 8 {H}_{2} \qquad EQ5$$

Liquid water is vaporized into water vapor and preferably mixed with the other feedgases before being fed into the plasma chamber. The residual heat from the plasma reaction can be used for vaporization.

As yet another example, adding hydrogen as an auxiliary reactant can have beneficial effects on the product mix and can suppress the formation of undesirable carbon solids. Hydrogen can be added from an external hydrogen source, or it can be recycled into the system. Since each single pass of CO₂ and methane co-feed can generate two additional molecules of hydrogen, and hydrogen is not consumed in the primary plasma reaction (i.e., the O in CO₂ combines with the C in CH₄ to form two molecules of CO and two molecules of hydrogen), the auxiliary feed of hydrogen can be completely recycled while simultaneously producing syngas of the desired ratio. The amount of hydrogen that is reused as a reactant in subsequent reactions will depend on the exact operating conditions of the plasma reactor; ratios of hydrogen, methane and CO₂ can be varied to accomplish the desired effects. In an embodiment, a 1:1:1 ratio of the three gases (methane, CO₂, and hydrogen) to each other has been shown to be advantageous in minimizing the production of carbon solids and other undesirable carbonaceous materials; in other embodiments, other ratios of these gases can be selected to achieve similar desired effects. In embodiments, other ratios of hydrogen to primary reactants can be selected to optimize the product mix, avoid fouling, and/or ensure efficient operation. While recycling is an efficient way to provide hydrogen as an auxiliary reactant, it is understood that hydrogen can also be provided as an auxiliary reactant from an outside source (i.e., without recycling), for example from a tank or from a dedicated hydrogen line.

In embodiments, additives can be introduced into the plasma reactor along with the primary reactants, methane (or other hydrocarbons) and CO₂. As used herein, the term “additive” refers to substances or materials that do not participate in or influence the primary reaction. Instead, they can be introduced into the plasma reactor in order to be affected by its physical and chemical conditions. As an example, colloidal particles can be introduced into the plasma reactor as additives along with the primary reactants, producing a feedgas that is a gaseous species loaded with the colloidal particles (also termed “additive particles” herein). The feedgas loaded with the additive particles can be termed a “complex feedgas.” Such a complex feedgas, when energized in the plasma reactor, produces what is termed a “complex plasma.” A complex plasma is a type of plasma in which additive particles ranging in size from millimeter-size to nanometer-size are levitated within the plasma gas. Use of colloidal particulate additives in conjunction with the plasma formation systems disclosed herein can yield valuable products, apart from those produced by the plasma energization of the primary reactants.

In more detail, the formation of complex plasmas involves the introduction of appropriate additive particles into the plasma, where the superheated plasma environment can affect the surface geometry of the particles or can energize their interactions to form more complex particulate arrays or to form core-shell heteroparticles or alloys. Such additive particles, having been energized in the plasma environment of the complex plasma, can be termed “energized additive particles.” To produce a complex plasma, additive particles can be introduced into the feedgas flow pattern at any point along the path and directed to pass through the plasma reactor to become energized additive particles. The point within the system where the additive particles are introduced is termed the “insertion site” herein. The use of such particles as additives is compatible with either a unidirectional flow path of feedgases within the plasma reactor, or a bidirectional flow path of feedgases within the plasma, both as described in more detail herein.

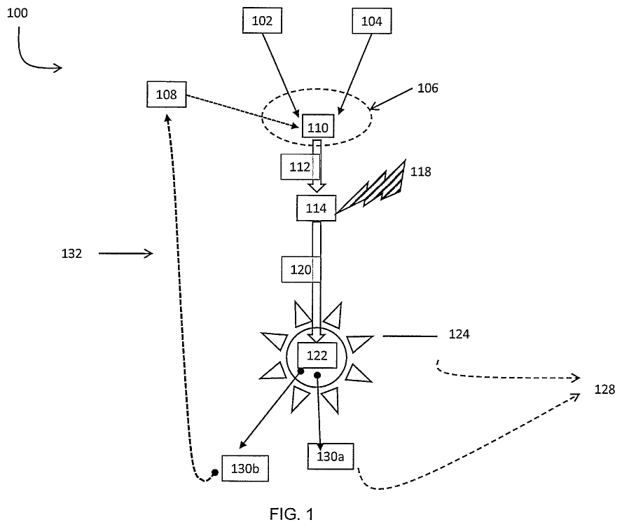

In embodiments, the feedgases enter and pass through the plasma reactor in a unidirectional flow path (illustrated schematically in FIG. 1 below and described in more detail below in connection with that Figure). In such embodiments, the feedgases enter the plasma reaction chamber in an antegrade manner, passing from the top (or “proximal”) end of the reactor into the chamber, with the reaction products exiting the bottom (or “distal”) end of the reactor. In such embodiments, the flow is unidirectional, flowing in a direct path from an entry point to an exit point. With a unidirectional flow path of feedgases within the plasma reactor, the additive particles can be fed into the reactor along with the feed gas, or can be introduced into the feed gas as it enters the plasma reaction chamber. A variety of insertion sites are available in the system for adding the additive particles, and a variety of insertion mechanisms can be readily envisioned by skilled artisans using no more than routine experimentation. In embodiments, the particles can be introduced through a nozzle that is separate from that used by the feedgas, in order to control their inflow and prevent them from obstructing the main feedgas flow. In embodiments, the feedgas can be passed through a bed of the particles before it enters the plasma reaction chamber, an arrangement that can fluidize and entrain the particles in the gas stream before it enters the plasma reaction chamber through the main injection nozzle. A nozzle or injector for adding the additive particles to the system at any point is termed an additive injector.

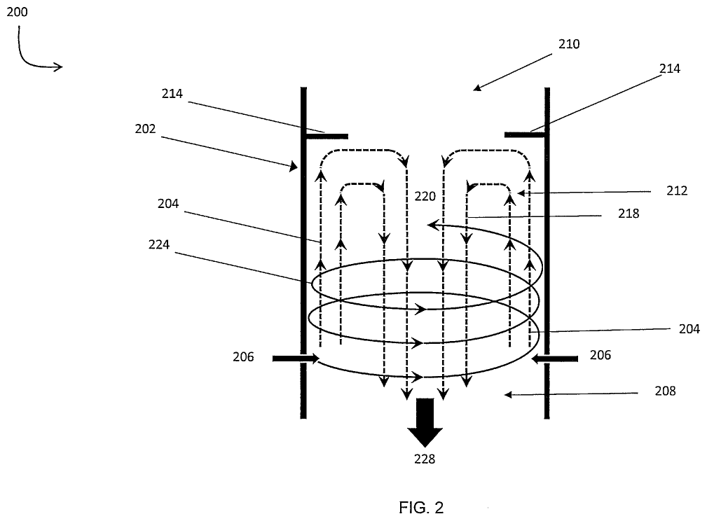

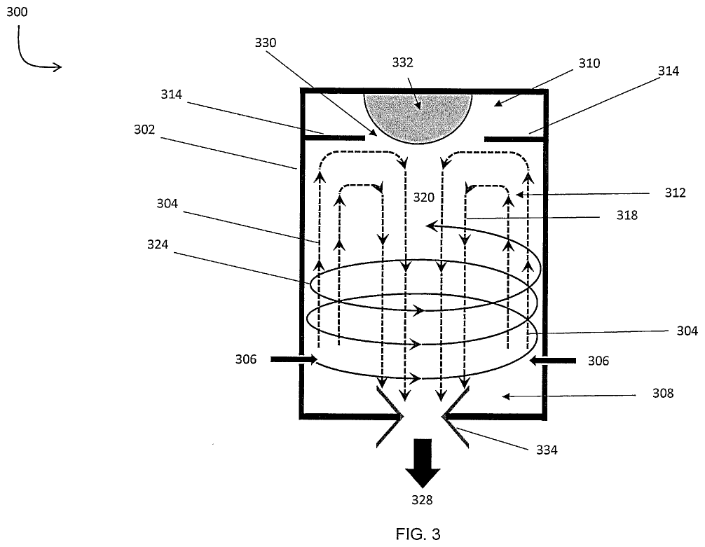

Additive particles can also be used in conjunction with bidirectional flow paths for feedgas injection. With the bidirectional flow path (illustrated schematically in FIGS. 2 and 3 below and described in more detail below in connection with those Figures), the particles can be fed into the plasma reaction chamber at an insertion site located at its bottom end, either entrained in the gas flow or via a separate nozzle; in other embodiments of a bidirectional flow path, the feedgas can enter the plasma reaction chamber at the bottom end, with the particles being introduced at an insertion site along the path from proximal to distal, or at an insertion site at the top where the vortexing gas reverses direction.

The bidirectional flow path within the reactor is especially suitable for the formation of complex plasmas and the production of specially engineered composite particles. Without being bound by theory, it is understood that complex plasma formation using the systems and methods disclosed herein can be optimized by the dynamics of the bidirectional flow path for feedgas injection (e.g., reverse vortex flow) disclosed herein, which prevents the particles from adhering to the reactor chamber wall and which thrusts the particles and the plasma jet out of the reactor at a high velocity and at a high temperature. It is further understood that a super-hot plasma such as is produced in the present reactor chamber (preferably using a bidirectional flow path for feedgas injection) can spheroidize otherwise irregular particles by softening them, melting them and allowing them to reform evenly with less surface area as they fall through the plasma chamber by gravity. A reducing environment such as is created by the inventive systems and methods is further advantageous for engineering desirable particle geometry.

A wide variety of particulate additives can be used for forming a complex plasma. A number of particle categories, including, without limitation, ceramics (e.g., alumina, magnesia, silica, calcium carbonate (precipitated calcium carbonate), silicon carbide, and the like, among numerous others) and elemental nanoparticles (such as carbon, aluminum, silicon, titanium, iron, copper, silver, cerium, platinum, and gold) or combinations or alloys thereof can be employed. In an embodiment, alloys such as those comprising nickel and iron (e.g., tetrataenite), or nickel/iron/phosphorous can be formed. Mixtures of metal-containing complexes can also be introduced into the plasma reaction as additives, with the metal-containing complexes suspended in a solution comprising organic ligands, with the complexes being released into the plasma stream when the organic ligands evaporate in the plasma chamber. Mixtures of metal-containing complexes can lead to alloys via a similar path, when the organic ligands flash off (evaporate). In addition, metal oxides can be reduced by a chemical-reducing plasma (such as mentioned below for ferric oxide conversion into iron). In embodiments, the particles can undergo chemical or other reactions as they pass through the plasma chamber. For example, they can become coated with carbon. Since the CO₂/hydrocarbon plasma described herein provides a reducing environment, this system is compatible with oxidation-sensitive particles such as iron, silicon, nickel, and the like; thus this system can avoid unwanted side reactions that would damage these particles if they were exposed to oxidation.

### 3. Systems for Stage 1 Reactions

Feedgases can be introduced into the plasma chamber separately as single gas inflow streams or as mixtures of two or more gases, or both; the mechanisms and pathways for introducing the feedgases or feedgas mixtures into the plasma chamber is called the “feedgas subsystem.” In embodiments, an injector can be used to control the flow rate and the flow direction of the feedgases or mixtures thereof within the feedgas subsystem. In one embodiment, an injector can be designed that creates a vortical flow pattern, for example by directing streams of gases through inlets at an angle to the axis of the reactor so that their flows form a vortex. Gas streams (containing single gases or mixed gases) can be dispersed in directions and with velocities to lead to their intermingling as they enter the reaction zone of the reactor, or prior to entering the reaction zone. In addition to those gas streams directed angularly, one or more gas streams can flow coaxially within the reactor; these various gas streams can be directed to coalesce before reaching the reaction zone of the reactor to form a single inflow stream, or they can be oriented so that their mixing is minimized. Other versions of a feedgas subsystem can be constructed by skilled artisans, using no more than routine experimentation.

Flow patterns for various inflow streams can be optimized within the feedgas subsystem in order to maximize the yield of desired products by varying the geometry or the temporal deployment of one or more of the inflow streams. In embodiments of a feedgas subsystem, the inflow streams can be directed to form selected geometric flow patterns. Vortical flow is an example of a geometrically arranged flow pattern that can include some or all of the feedgas streams. Advantageously, the flow pattern used to create the vortex is symmetrical. Vortical flow, involving some or all of the feedgases used in these systems and methods, can be designed to enhance the mixing of the feedgases, or to separate some or all of the feedgases from each other as they enter the plasma. In embodiments, a vortical flow can form a single vortex or can form multiple vortices either simultaneously or at different points in time during the vortical flow.

FIG. 1 (also referenced above) provides a block diagram showing a unidirectional flow path for converting CH₄ and CO₂ into syngas in an exemplary embodiment of a plasma-based system 100. As shown in this Figure, gas flow enters a feedgas subsystem 106 at the proximal end of the system 100 to be processed within the reaction chamber 114, with reaction products exiting a distal end of the reactor. As shown in this Figure, one or more inflow gases 102, 104, and (optionally) 108 are directed into a feedgas subsystem 106 comprising a mixing chamber 110 or other mixing mechanism to produce a mixed inflow stream 112 that is directed into a plasma reaction chamber 114 (or “reactor”), where the entering feedgases are ionized and converted into a plasma by exposure to energy 118 such as microwave energy. The feedgases include a hydrocarbon stream 102 comprising a hydrocarbon such as methane or ethane or propane, a carbon dioxide stream 104, and (optionally) one or more auxiliary feedgases in an optional auxiliary feedgas stream 108. While this Figure shows only a single auxiliary feedgas stream, which can comprise one or more auxiliary feedgases in the single stream, it is understood that more than one optional auxiliary feedgas streams (not shown) can be employed. As shown in FIG. 1, the feedgas streams 102, 104, and (optionally) 108 converge on the mixing chamber 110, within which they are mixed to produce the mixed inflow stream 112. However, in other embodiments, the mixing chamber 110 is optional, and the feedgas streams 102, 104, and 108 can be directed into the plasma reaction chamber 114 individually through a feedgas subsystem 106 without prior mixing, or with prior mixing of two or more of the entering feedgases (such as CO₂ and CH₄) while others (e.g., an auxiliary feedgas such as H₂) can be introduced separately without prior mixing. As shown in the Figure, the auxiliary feedgas stream 108 can optionally be obtained by recycling 132 an auxiliary gas 130b such as hydrogen that has emerged from the reactor 114 as one of the outflow products 122. Other auxiliary gases such as nitrogen or argon can, optionally, be introduced as auxiliary feed gases 108 in addition to or instead of hydrogen from separate gas sources (not shown); similarly, hydrogen can be provided as an auxiliary feedgas 108 from a separate gas source (not shown), instead of or in addition to being recycled. This system 100 is also compatible with the introduction of additives into the gas flow, although such a feature is not depicted in the Figure.

The directing of the gases 102, 104, and optionally 108 into the plasma reaction chamber 114 is represented schematically by the arrow 112. This process, involving a feedgas subsystem 106, can include an injector, such as a gas injector (not shown), as described in connection with the embodiments depicted in FIGS. The plasma formed in the plasma reaction chamber 114 is produced by energy 118 from an energy source. In an embodiment, the energy 118 for forming the plasma is microwave energy. Other methods can be used as well to create the plasma in the plasma reaction chamber 114; for example, a dielectric barrier discharge system, an arc discharge, or other plasma generating system can be used for the formation of a non-thermal plasma.

Emerging from the plasma reaction chamber 114 is a gaseous outflow stream 120 that carries the products formed in the plasma as a mixture of products 122. The gaseous outflow stream 120 can deliver a mixture of products 122 (or “product mixture”) such as carbon monoxide, hydrogen, unreacted feed gases, water, carbon solids, and more complex carbon-containing compounds. In addition, the gaseous outflow stream 120 contains a substantial amount of thermal energy 124, which can be employed to energize derivative reactions 128. The mixture of outflow products 122 in the outflow stream can be separated into a products component 130a comprising syngas, and an optional recycling component 130b, which can be recycled 132 back into the system 100 as an optional auxiliary feedgas 108. For example, when the component 130b for recycling is hydrogen, it can be reintroduced into the system 100 as an optional auxiliary feedgas 108 to be combined with fresh inflow gases 102 and 104, having the beneficial effect of reducing the production of carbon solids in the plasma reaction chamber 114. The products component 130a can be removed from the system without alteration (not shown), using separation and product recovery methods familiar in the art. The products component 130a can also undergo derivative reactions 128 through which the chemicals comprising the product component 130a are converted into other chemicals.

While the depicted flow path shown in this Figure is a unidirectional one, in which the feedgases proceed from their entry points through a feedgas subsystem 106 into the reaction chamber 114, to exit the reaction chamber as a gaseous outflow stream 120 containing products 122. In the depicted embodiment, the feedgases enter through the feedgas subsystem 106 at one end of the system 100 and proceed linearly through the plasma reactor chamber 114 towards the outflow end where they emerge as outflow products 122.

In other embodiments, not shown in FIG. 1, the feedgases to be processed in the plasma system follow a bidirectional flow path: they enter at the distal end of the reactor then flow retrograde towards the proximal end, at which point they reverse flow direction and flow from the proximal end of the reactor distally into and through the reactor chamber, with the reaction products exiting the distal end of the reactor. In such an embodiment, the feedgases can be arranged to flow vertically, disposed along the peripheral aspect of the reactor; with the reversal of flow at the top of the chamber, the feedgases are directed to flow towards the center of the reactor to be energized as a plasma.

A schematic representation of a bidirectional flow path for feedgas injection is presented in FIG. 2 (also referenced above). FIG. 2 depicts schematically an embodiment of a reactor arrangement 200 showing a bidirectional flow path within a plasma reactor chamber 202 suitable for use with the reaction systems disclosed herein. As shown in the Figure, an inflow 204 of one or more feedgases enters the plasma chamber 202 through one or more inflow nozzles 206 and is conveyed retrograde from a distal portion of the chamber 202 (here, the bottom end 208) to the top end 210 of the chamber 202 via a path that proceeds along the periphery 212 of the chamber 202. This system is also compatible with the introduction of additives into the gas flow, although such a feature is not depicted in this Figure. In embodiments, the inflow 204 is directed to follow a vortical flow path 224 as it proceeds towards the top end 210. At the top end 210 of the chamber 202, the inflow 204 encounters a top barrier 214 which redirects and reverses its flow. This top barrier can partially or completely obstruct the upward motion of the vortical flow path 224. Advantageously, this top barrier 214 can be shaped to reverse the vortical flow 224 more smoothly, such as with an inverted dome (not shown). The redirected flow 218 is then directed distally to proceed through the central portion 220 of the plasma chamber 202 to be processed as a plasma (not shown) within the plasma chamber 202, with the outflow products 228 exiting the bottom end 208. In embodiments, the outflow products 228 can be passed through a nozzle (not shown) that prevents back flow into the main plasma chamber 202, for example, a converging-diverging nozzle.

Varying the geometry of the vortex or vortices entering the reaction zone of the plasma reaction chamber can be modulated to optimize product mixes and reaction efficiencies. In embodiments, the inflow streams can be directed into flow patterns having temporal variability, a feature that can be engineered to achieve desired product mixes and reaction efficiencies. For example, the flow pattern of feed gases can involve a constant inflow of gases at a constant rate, or it can involve inflow of one or more gases at variable flow rates, in discontinuous flow patterns, or having other variations. As examples, gases can be introduced at different rates at from different inlets, or gases can be introduced with different flow patterns (such as varying continuous patterns, or patterns having intervals of discontinuity), with the flow patterns being the same at all inlets or differing at different inlets. Feed gases can also be introduced laterally along the reactor tube instead of at an end. Appropriate geometric and temporal flow patterning and variations thereof can be determined by skilled artisans in order to accomplish specific goals, for example to select for a particular product mix or to suppress soot formation in the reaction chamber.

It is understood that mechanisms for stopping backflow of products can be advantageous when downstream derivative reactions are to be carried out; such derivative reactions are discussed below in more detail. It is further understood that the extreme heat from direct exposure to the plasma (not shown) may be detrimental to primary or derivative reactions, or that these reactions may produce byproducts (e.g. solid particles) when exposed to direct plasma that cause instability in the plasma region, impeding practical operation. Thus, the bidirectional flow path for feedgas injection in FIG. 3 (also referenced above) depicts schematically certain modifications that can achieve these goals, offering mechanisms consistent with the principles of the invention. This system is also compatible with the introduction of additives into the gas flow within or exiting the reaction chamber, although such a feature is not depicted in the Figure.

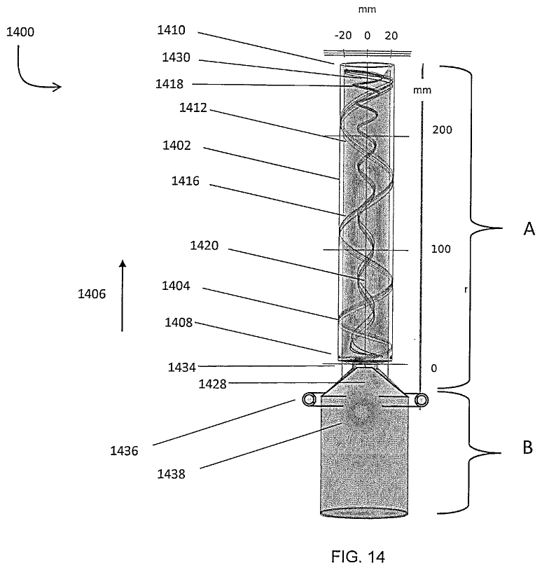

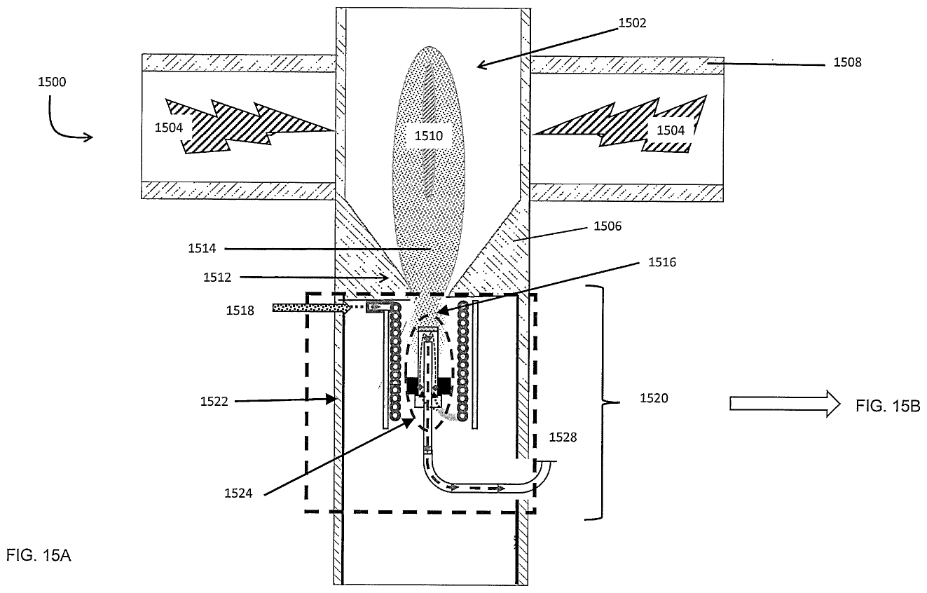

In more detail, FIG. 3 shows schematically a reactor arrangement 300 having a bidirectional flow path (shown by the dotted lines) within a reaction chamber 302 suitable for use with the reaction systems disclosed herein. As shown in the Figure, an inflow 304 of one or more feedgases enters the plasma chamber 302 through one or more inflow nozzles 306 and is conveyed retrograde from a distal portion of the chamber (here the bottom end 308) to a proximal portion of the chamber (here the top end 310) via a path that proceeds along the periphery 312 of the chamber 302. In embodiments, the inflow 304 is directed to follow a vortical flow path 324 as it proceeds towards the top end 310. At the top end 310 of the chamber 302, the inflow 304 can encounter a top barrier 314 which redirects and reverses its flow. As shown in the Figure, the top barrier 314 can extend partially across the width of the chamber 302, having a central open area 330 above which is positioned an inverted dome 332 or other modification of the top end 310 intended to shape the geometry of the reversed flow stream. The inverted dome 332 can intrude into the central open area 330 or can be positioned above the central open area 330 as shown in this Figure. Advantageously, the position of the inverted dome 332 is selected to permit the vortical flow 324 to be reversed smoothly as it encounters the top barrier 314. In other embodiments, not shown here, the top barrier 314 can be eliminated entirely, with the inverted dome 332 or other top end 310 modification being positioned at the top end 310 of the chamber to deflect the vortical flow 324 smoothly and reverse its direction. In embodiments, the inverted dome can be positioned at the top end of the chamber without any other barrier structures; such an embodiment is depicted in FIG. 14 below, and described in more detail by reference to that Figure. In either case, whether the inverted dome 332 or other top end 310 modification is combined with a top barrier structure 314, or whether the inverted dome or other top end 310 modification is positioned by itself at the top end 310 of the chamber 302, it combines with the other structural elements at the top end 310 of the chamber to redirect the vortical flow 324, so that the redirected flow 318 is directed distally in an antegrade direction to proceed through the central portion 320 of the plasma chamber 302 to be processed by the plasma (not shown) within the plasma chamber 302, with the outflow products 328 exiting the bottom end 308. As shown in this Figure, a nozzle 334 is provided (for example a converging-diverging nozzle) that passes the outflow products 328 out of the reaction chamber 302 and prevents their backflow.

### 4. Derivative Reactions

The systems and methods disclosed herein can be used simply for the formation of syngas in a primary reaction (also termed a Stage 1 reaction) as described above, and the syngas can then be separated from the system as a mixture of CO and H₂ for other uses, or for separation into its component molecules CO and H₂. In addition to such primary reactions, the systems and methods disclosed herein can be used to produce a wide spectrum of derivative reactions. As used herein, the term “derivative reaction” (also termed a “Stage 2 reaction”) refers to a second reaction produced outside the plasma reaction chamber using the chemicals and/or the heat energy generated by the primary reaction that had taken place in the plasma reaction system, optionally to react with externally provided additional chemicals or externally provided more complex substances containing additional chemicals. Such externally provided additional chemicals or externally provided more complex substances containing additional chemicals are termed “external reactants.” Those products produced by derivative reactions are termed “derivative products,” and these derivative reactions take place in a derivative reaction zone or in a larger region for derivative reactions within the Stage 2 apparatus.

Those derivative reactions that are carried out just using the heat energy generated by the plasma reaction system are termed “heat-focused derivative reactions.” The two-stage reaction scheme disclosed herein allows us to direct external reactants directly into the hot jet emerging from the plasma reactor. External chemicals or more complex substances introduced into the system to be acted upon by this thermal energy can be termed “reaction targets” (singular or plural) for the heat-focused derivative reactions; the term “reaction target” refers to those external reactants used in heat-focused derivative reactions. These heat-focused derivative reactions direct the heat from the primary plasma-based reaction to energize other reactions that take place between other chemicals (generically, external reactants, but specifically reaction targets) outside the primary reaction chamber, without using as reactants those chemicals produced by the primary reaction. Those products produced by heat-focused derivative reactions are termed “thermal derivative products,” and these heat-focused derivative reactions take place in a heat-focused derivative reaction zone or in a larger region for derivative reactions within the Stage 2 apparatus.

Those derivative reactions that use the chemicals or substances (such as the composite particles produced from additives in a complex plasma) formed by the primary reaction to produce other chemicals or materials are termed “chemical-focused reactions.” These reactions either alter the substances produced by the primary reaction itself to form other products, or combine the substances produced by the primary reaction with other external reactants that are added to the system separately from and distal to the reaction chamber; those external reactants that are employed in chemical-focused reactions are termed “secondary reactants.” The subtype of chemical-focused reactions involving the chemical combination of primary reaction products with a secondary reactant is termed a “secondary reaction,” and such a reaction takes place in a secondary reaction zone or in a larger region for secondary reactions.

a. Heat-Focused Derivative Reactions

As described above, the systems and methods disclosed herein use plasma energy to react a hydrocarbon such as methane and CO₂ in order to produce CO and H₂, with the simultaneous release of thermal energy. Heat-focused derivative reactions employ this thermal energy to energize reactions between external reactants, i.e., chemicals or substances that are external to the primary plasma reaction, without involving the chemical products of the plasma reaction. As mentioned previously, those external reactants employed in heat-focused derivative reactions are termed “reaction targets.” In embodiments, a variety of chemicals can be treated as reaction targets in heat-focused derivative reactions in accordance with the systems and methods disclosed herein.

In embodiments, more complex substances can serve as reaction targets for heat-focused derivative reactions in accordance with these systems and methods, including intact substances comprising multiple types of reaction target molecules, such as biomass. In such reactions, the complex substance can contain or be a source of chemicals that can act as reaction targets for further derivative reactions.

Non-limiting examples of specific heat-focused derivative reactions are provided below.

As examples of heat-focused derivative reactions involving chemicals as reaction targets, a variety of desaturation reactions (such as ethane-to-ethylene, ethane-to-acetylene, propane-to-propylene, butane-to-butadiene, ethylbenzene-to-styrene, and the like) can be performed in such derivative reactions by providing a saturated reaction target that can be converted by exposure to thermal energy into an unsaturated one via heat-mediated desaturation. These desaturation derivative reactions can also be termed “cracking” reactions, and the reaction targets can be described as being “cracked” by such a reaction to produce the thermal derivative products. Such reactions resemble those considered to be traditional “cracking” reactions; however, the cracking reactions enabled by these systems and methods take advantage of excess heat produced by the plasma reaction, and do not employ steam, as is often used in traditional cracking. For example, if ethane is used as a reaction target, it can be readily cracked by the reactor's heat to form ethylene along with other hydrocarbon byproducts. Thus, the final product composition of such a sequential reaction system can be a mixture of hydrogen, acetylene, and ethylene, with the latter two products quantitatively adjustable by the relative feed rates of primary reactants into Stage 1 and reaction targets into Stage 2. In short, this design creates a fully sustainable alternative for either acetylene-rich or conventional ethylene-dominant crackers, and provides a template for alternatives to other greenhouse-gas-emitting cracker operations.

Other examples of heat-focused derivative reactions, in which the excess heat from the reactor drives a chemical reaction, include the cyclization of acetylene to make benzene, and the pyrolysis of hydrocarbons such as (without limitation) methane, ethylene, and acetylene, and heavier hydrocarbons, including (without limitation) those complex hydrocarbons that are found in materials such as biomass (e.g., lignin+ cellulose+ (hemi) cellulose), synthetic polymers (polyethylene, polypropylene, polystyrene, etc.), and petroleum residua materials (i.e., the petroleum fractions such as bitumen or asphalt, and heavy crude oils, typically remaining after distilling out lighter grade petroleum components). As in the desaturation reactions described above, these types of reactions do not involve any of the chemical products from the plasma reaction but rather are driven by the excess heat that the plasma produces when the heat encounters acetylene as the reaction target. Follow-on tertiary reactions are possible subsequent to the derivative reactions produced by heat energy, such as hydroformylation reactions to produce aldehydes from the alkenes produced as described above, and subsequent hydrogenation of such aldehydes to produce alcohols.

More complex tertiary reactions are possible as well, in which the products of the heat-focused derivative reactions are processed to form other, tertiary products. Such tertiary reactions following derivative reactions can include processes such as reacting the thermal derivative products with each other or to react with another tertiary reactant (e.g., a tertiary reactant that are added to the products of the heat-focused derivative reactions from outside the system), or a tertiary reactant that is a component of the syngas produced in Stage 1. As an example, polyketone polymers such as ethylene-carbon monoxide copolymers can be synthesized from the carbon monoxide produced in Stage 1 in combination with the ethylene or other olefins produced during Stage 2 cracking. Selection of appropriate catalysts allows the desired polymer configuration to be formed with a specific insertion pattern of the carbonyl and olefin monomers, for example to form perfectly alternating CO-olefin copolymers, nonalternating CO copolymers, or other desired arrangements (e.g., alternating copolymerization of CO with terminal alkenes) depending on the properties being sought for the polymeric material.

In certain heat-focused derivative reactions involving individual chemicals as reaction targets, the thermal energy generated by the plasma reaction can be used to break larger molecules in the reaction target (such as polymers and macromolecules) into smaller chemical products. As an example, the thermal energy from the plasma reaction can be transferred to the reaction target by exposing the reaction target to the hot syngas, with the hot syngas simply being employed as a vehicle for conveying the thermal energy to the reaction target without being involved itself in a chemical reaction. Using the systems and methods disclosed herein, the heat produced by the plasma reaction can be employed to pyrolyze large molecules as reaction targets, turning them into smaller, high-value fragments. It is highly desirable to break down polymers and macromolecules to form usable oligomers and monomers, especially for those polymers and macromolecules typically considered waste materials.

As an example, lignin can be used as a reaction target in a heat-focused derivative reaction, yielding via pyrolysis a variety of oxygenated aromatic compounds including alcohols, phenols, aldehydes, and carboxylic acids. These smaller molecules can be readily separated from the plasma effluent and further purified using conventional separation techniques. Alternatively, the products of lignin pyrolysis resulting from the heat-focused derivative reactions can be used directly to form a bio-oil that can provide a sustainable fuel.

Lignin is a particularly advantageous reaction target for heat-focused derivative reactions because it is ubiquitous but is scarcely used commercially due to its intrinsic resistance to chemical reactivity; at present, the overwhelming majority of lignin is simply burned for its fuel value. Its unreactive state combined with its complex structure makes depolymerization of this molecule extremely challenging: the mechanism of lignin biosynthesis produces a polymer that lacks any ordered and regular repeating units, rendering it particularly difficult to depolymerize. These structural impediments need to be overcome if lignin is to find productive use as a resource for other reactions.

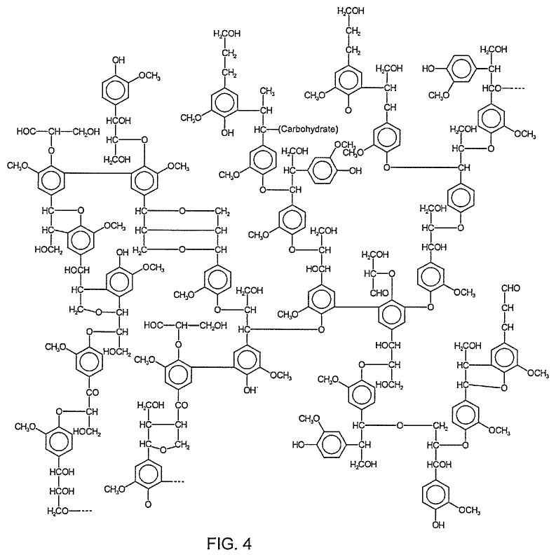

Lignin's molecular structure comprises numerous aromatic rings connected by aliphatic bridges. It can be viewed as a network of crosslinked monolignols, as shown in FIG. 4. The three principal monolignols are paracoumaryl alcohol, coniferyl alcohol, and sinapyl alcohol. Thus, lignin represents a huge storage of phenolic alcohols if they could only be retrieved. Using the systems and methods disclosed herein, lignin depolymerization (i.e., de-crosslinking and/or bridge-breaking) to retrieve constituent building blocks can be accomplished by exposing lignin to the thermal energy produced by the plasma-based systems and methods disclosed herein, thereby unlocking the huge utilization potential of this important natural resource. If controllably degraded to allow preservation of constituent integrity and properties, lignin can yield products that are useful in high-value applications, including as natural pigments, co-reactants for thermosets (urethanes, epoxies, and formaldehyde resins), bio-fuel additives (e.g., oxygenates), fine-chemical and surfactant building blocks, and as precursors for other important compounds, such as cresols, catechol, resorcinol, quinones, vanillin, and guaiacol.

As further examples of heat-focused derivative reactions, complex natural polymers such as cellulose or hemicellulose can be pyrolyzed by the thermal energy produced by the syngas plasma effluent, as disclosed herein. While cellulose and hemicellulose have a number of commercial uses (in comparison to lignin, for example), pyrolyzing these biopolymers can generate even more valuable products such as furans, pyrans, and aliphatic oxygenates, a different set of products than those produced by lignin pyrolysis.

Another example of a complex molecule that can be converted into smaller, useful products by pyrolysis via these systems and methods is bitumen. Bitumen in its native state is either a very viscous liquid form or a solid form of petroleum. Commonly known as asphalt, bitumen is used primarily for paving roads and roofing, although it can be upgraded and processed (e.g., refined) into lighter oils. By using it as a reaction target for a heat-focused derivative reaction, the systems and methods disclosed herein can fracture it into a large and varied portfolio of lighter compounds. These systems are especially suitable for treating bitumen in the field or at other sources of this raw material. Because of the modularity of the plasma-based systems disclosed herein, especially due to the use of microwave energy to produce the plasma, pyrolysis reactors can be installed directly where bitumen is being extracted to break it down into smaller hydrocarbon fragments, thereby forming lighter oils in liquid or gaseous form. Converting bitumen into these lighter hydrocarbon products on-site makes transport easier since these fluids can be moved through pipelines more readily.

These systems and methods are also applicable to the treatment of a wide range of other macromolecular hydrocarbon “super-structures” into smaller oligomeric or monomeric building blocks. As an example, the macromolecular hydrocarbon superstructures found in petroleum residua materials such as crude oil “bottoms” can be treated in this way. The hydrocarbon macromolecules in crude oil “bottoms” comprise asphaltenes, large organic molecules with very high boiling points. The plasma effluent from the Stage 1 reactor conveys enough heat energy to break the bonds in the asphaltene molecules, and the reducing nature of the syngas forming the Stage 1 plasma effluent prevents oxidation of those molecules. Thus, these heat-focused derivative reactions directed towards the components of crude oil “bottoms” only cause bond scission, mainly of those single bonds connecting the aromatic rings in the asphaltene macromolecules. Besides this heat-induced cracking of these large molecules, there is the possibility of chemical reaction between the asphaltene molecules and the hydrogen in the syngas effluent, causing hydrogenation of the cracked molecules; this hydrogenation can upgrade some of the cracked molecules to form more valuable products. The array of products from these heat-focused derivative reactions can be used in numerous applications, such as feedstocks for downstream chemical manufacture and ingredients for making gasoline/fuels, lubricants, and additives.

In an exemplary system, a source of complex hydrocarbon macromolecules (the “spent oil”) such as crude oil bottoms or waste oil can be integrated with a plasma reactor as disclosed herein, so that the atomized droplets of the spent oil can be directed to encounter the hot syngas-containing effluent from Stage 1, with the spent oil being rapidly pyrolyzed and optionally upgraded by hydrogenation from the hydrogen in the syngas. While spent oil management is typically a batch process, the inventive systems can provide continuous processing of the spent oil to form the desired cracked, and optionally hydrogenated, products.

Using the systems and methods disclosed herein, pyrolysis can be accomplished on virtually any type of polymer or macromolecule by exposing it to the thermal energy generated by the CO₂+hydrocarbon plasma. This is particularly advantageous as a treatment for those polymers that are difficult to recycle or reuse. Exposing a polymeric reaction target to lower temperatures can produce large hydrocarbon molecules that can be used as fuels. Exposing such polymeric reaction targets to higher temperatures can promote the formation of smaller molecules and, with appropriate temperatures, monomer formation, including ethylene, acetylene, propylene, and styrene; the resulting products can then be valorized to make new polymers or other substances. The temperature for the heat-focused derivative reaction can be tuned to yield the desired end products formed from the pyrolysis of the polymeric reaction target.

As examples, synthetic hydrocarbon-derived polymers such as polyethylene, polypropylene, polystyrene, and the like, can be broken down into smaller fragments and even monomers. As another example, this technology can be readily applied to the pyrolysis of fluorinated molecules and fluorinated synthetic polymers (e.g., per- and polyfluoroalkyl substances (PFAS)), which are highly resistant to chemical breakdown due to their stable carbon-fluorine bonds. These compounds are a recognized environmental pollutant and health hazard to humans; destroying these compounds is challenging, but pyrolyzing them at high temperatures offers a solution. Pyrolysis at 500-800° C., as can be accomplished by using them as reaction targets for a heat-focused derivative reaction in accordance with the systems and methods disclosed herein, can break down fluoropolymers such as polytetrafluoroethylene (Teflon®) into C₂ and C₃ fluorocarbons. This allows for their removal from waste streams or for their recycling into new fluoropolymers.

As another example, pyrolysis can be carried out by the systems and methods disclosed herein to convert a hydrocarbon-containing reaction target into carbon solids such as graphene, carbon nanotubes, fullerenes, activated carbon and related materials such as biochar, charcoal, and the like, and various grades of carbon black (acetylene black, tire black), whether structured or unstructured, organized, amorphous, disorganized or otherwise. In embodiments, specific hydrocarbons (e.g., methane, ethane, ethylene, and acetylene (alone or mixed with each other)) can be used as reaction targets, to be subjected to thermal energy produced by the plasma system. Ethylene has been identified as a particularly advantageous reaction target for the formation of such carbon solids, for example, carbon nanotubes and conductive carbon solids; ethylene can also be mixed with ethane or with acetylene or both to provide a reaction target for producing such carbon solids.

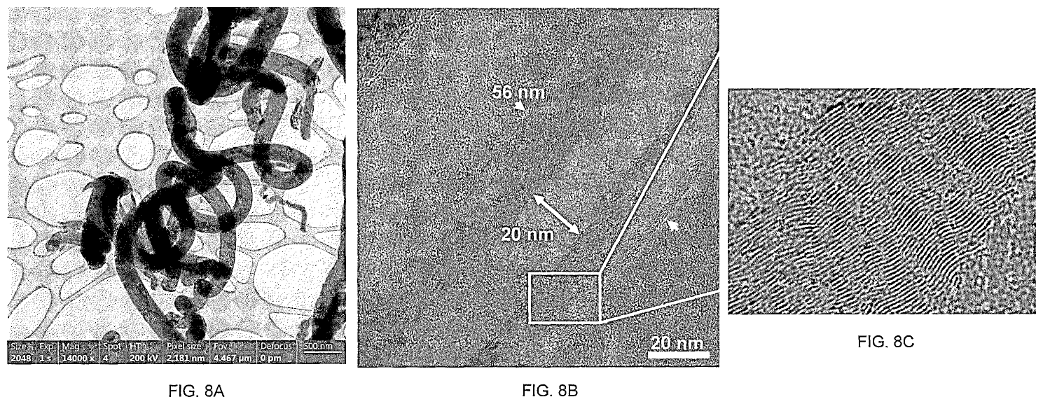

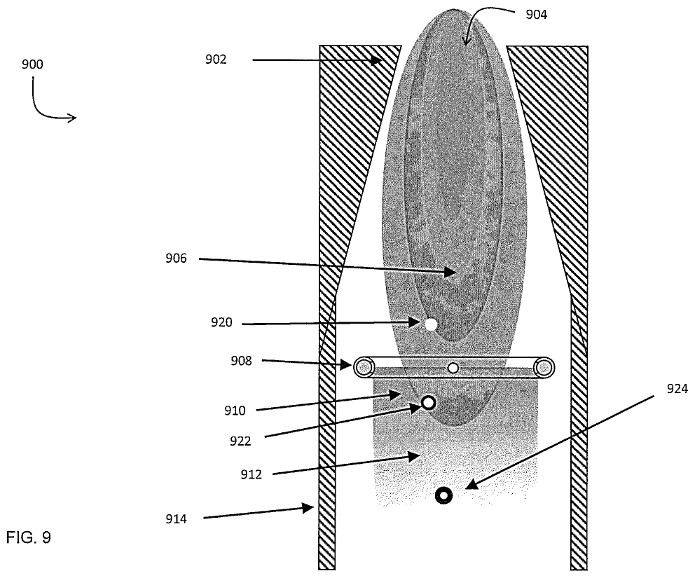

As a non-limiting example, Example 3 (described below) details an experiment for forming carbon nanotubes via the second-stage injection of ethane as a reaction target. Exemplary images of the multiwalled nanotubes produced by this experiment are shown in FIGS. 8A-C, described below in more detail. It has also been discovered that other hydrocarbon reaction targets (e.g., methane, ethane, ethylene, and acetylene (alone or mixed with each other)) can be used similarly to form carbon solids such as graphene, carbon nanotubes, fullerenes, activated carbon and related materials such as biochar, charcoal, and the like, and various grades of carbon black (e.g., acetylene black, tire black) whether structured or unstructured, organized, amorphous, disorganized or otherwise, under suitable conditions for these reactions.

In other embodiments, pyrolysis can be carried out by the systems and methods disclosed herein using complex substances such as biomass as reaction targets. In this sort of heat-focused derivative reaction, the thermal energy from Stage 1 serves to convert the hydrocarbon-containing reaction target(s) and the reactive chemicals therein (i.e., the polysaccharide polymers cellulose and hemicellulose and the aromatic polymer lignin) into other chemicals and materials, including without limitation the full spectrum of carbon solids. In an embodiment, the biomass itself, while comprising reactive chemicals, is used as the reaction target for the thermal energy, thus eliminating the need for extra steps to process the biomass and extract the cellulose and lignin polymers that will undergo pyrolysis.

Biomass is an attractive reaction target for use with these systems and methods for several reasons. Biomass can be derived from vegetable or animal sources; the most common materials are vegetable-based: plants, wood, and waste products derived from the foregoing. Virgin vegetable-based biomass is found in naturally occurring plants like trees, bushes, and grass. Virgin vegetable-based biomass can further include specialty-purpose crops such as switchgrass and elephant grass cultivated for uses such as biofuels, capable of multiple harvests. Virgin vegetable-based biomass also includes wood products, such as are formed from harvesting the structural components of plants (e.g., tree trunks, branches, stems, and the like). Waste materials can be produced from the consumption or harvesting of virgin biomass in industries such as agriculture (e.g., corn stover and corncobs, sugarcane bagasse, straw, oil palm empty fruit bunch, pineapple leaf, apple stem, coir fiber, mulberry bark, rice hulls (or husks), bean hulls (or husks), soybean hulls (or husks, or “soyhulls”), cotton linters, blue agave waste, North African glass, banana pseudo stem residue, bamboo fibers, walnut shells, coconut husks, groundnut shells, pistachio nut shells, grape pomace, shea nut shell, passion fruit peels, fique fiber waste, sago seed shells, kelp waste, juncus plant stems, and the like), or forestry (saw mill and paper mill discards). As examples, agricultural waste, such as coffee grounds, wood flour, wood chips, saw dust, bagasse pulp, hardwood and softwood pulp, beet grounds, ground rice hulls, banana fiber, bamboo fiber, lignin, hemp fibers, recycled wood pulp, or any combination of these, are common species of biomass.

Biomass conventionally is used as fuel, subjecting it to combustion to transform its constituent carbohydrates into CO₂, water, and energy. Vegetable-based biomass in the form of plants is made up of fibrils composed of units of polymeric cellulose intimately associated with hemicelluloses through hydrogen bonds; hemicelluloses in turn are covalently linked to lignin to form lignin-carbohydrate complexes. When the lignocellulosic polymers that form biomass are combusted as fuel in an oxygen-containing environment, they release the carbon dioxide that was originally stored in these polymers by photosynthesis. To avoid this outcome, the systems and methods disclosed herein can be employed to subject biomass to pyrolysis, to transform its constituent carbohydrates into other chemicals.

Using the systems and methods disclosed herein, biomass serves as a reaction target for a heat-focused derivative reaction, with the substance being treated with the thermal energy in the Stage 1 effluent. In this way, the chemical components of the biomass are pyrolyzed, yielding an array of products. The syngas produced in the Stage 1 plasma reactor is the vehicle for transporting the plasma-produced thermal energy from Stage 1 into Stage 2. Notably, syngas is a reducing environment; there is no oxygen available in the syngas effluent from Stage 1 that would cause oxidation.

As described previously, the complex natural polymers in the biomass, such as cellulose, hemicellulose, and lignin, can be pyrolyzed to generate a number of commercially valuable products, including (for the celluloses) chemicals such as furans, pyrans, and aliphatic oxygenates, and including (for the lignins) various oxygenated aromatic compounds including alcohols, phenols, aldehydes, and carboxylic acids. In embodiments, the encounter of thermal energy from Stage 1 with the complex natural polymers in biomass as reaction targets can lead to the conversion of such reaction targets into carbon solids such as graphene, carbon nanotubes, fullerenes, activated carbon and related materials such as biochar, charcoal, and the like, and various grades of carbon black (acetylene black, tire black), whether structured or unstructured, organized, amorphous, disorganized or otherwise.

According to one pyrolysis pathway, hydrogen atoms in the heated biomass (or in waste oils such as bitumen or tar) can be cleaved off and valorized separately, leaving fully reduced carbonaceous solids as residua. While certain of these solids can be recovered as specific carbon products, the carbonaceous residua can also be collected as an agglomerate of carbon solids that can be commercialized as biochar, a stable, carbon-rich solid that can be used as a soil amendment or storage vehicle for carbon sequestration. This mechanism, with the production of carbonaceous residue marketed as biochar, enhances the net effects of carbon sequestration in two stages: 1) the growth of the biomass itself removes CO₂ from the atmosphere via photosynthesis, and 2) the pyrolysis of biomass using the systems and methods disclosed herein results in the transformation of the biomass into usable or storable carbon solids (i.e., biochar) without the carbon being oxidized to form planet-warming CO₂.

In embodiments, the biomass substances can be dried and pulverized separately to form a finely grained powder, which in turn can be injected into the Stage 2 system electrostatically or in a spray carried by a gas. In other embodiments, the biomass powder can enter on a conveyor belt, screw feeder, or other mechanical vehicle that is exposed to the hot effluent exiting the plasma reactor, for example by passing under or through the effluent stream. If the spray mechanism for powder injection is selected, the biomass powder can be carried by a high energy molecule such as ethylene or acetylene and can optionally be supplemented with a small amount of oxygen, all of which mechanisms can create a controlled degree of combustion that augment the available thermal energy and thus can aid with transforming the biomass into biochar. The biomass powder can enter the Stage 2 system at a designated level to maximize its exposure to the thermal energy effluent from Stage 1. This point of entry for the biomass powder will define a very narrow reaction zone in the Stage 2 system, where the biomass morphs almost instantaneously into biochar.

Advantageously, the systems and methods disclosed above can be utilized for the production of activated carbon as well as biochar. The hot syngas effluent from the Stage 1 reactor retains a temperature of about 1500° C., which can be used for pyrolysis as described herein, moreover, as previously mentioned, syngas is a chemically reducing environment. These features permit the direct formation of biochar from biomass as described above; biochar in turn can be rapidly converted into activated carbon. Activated carbon (AC) is a carbon solid having a porous amorphous structure, with cylindrical, rectangular or irregular shapes pores of diameters ranging from 0.8 to 10 nm (micropores), 10-50 nm (mesopores), and 50-2000 nm (macropores). The substance thus exhibits high surface areas, ranging from 700 to 1800 m² g⁻¹, and its pore surface is non-polar, allowing it an avid affinity for non-polar adsorbates (mostly organic substances). A typical adsorption capacity for activated carbon is ˜20-25 g solvent per 100 g AC.

Activated carbon is conventionally produced by physically or chemically activating biochar under strenuous conditions. Instead, using the inventive systems and methods, activated carbon can be produced from biomass as follows. First, biochar is produced from biomass by subjecting it to the thermal energy in the Stage 1 syngas-containing effluent. Any residual biomass and the pyrolyzed biochar, all carried as a powder, enter a jet-powder contact zone where they are further transformed by exposure to the thermal energy, undergoing several simultaneous reactions to become converted to activated carbon. In more detail, the oxygen atoms contained in the biomass feed are converted almost instantaneously into superheated steam, which creates the high interior surface area characteristic of AC; and excess hydrogen that is cleaved from the biomass/biochar is preserved, further enriching the hydrogen content of the syngas effluent. Notably, these processes for producing AC can be performed continuously during the operation of the Stage 1 process without requiring additional energy input, with the production of AC resulting simply from the treatment of the biomass and biochar by the thermal energy in the Stage 1 effluent.

The heat energy from Stage 1 can be used in other productive ways for heat-focused derivative reactions in Stage 2. In embodiments, these reactions can take advantage of the reducing environment provided by the presence of syngas in the Stage 1 effluent entering into Stage 2. For example, ferric oxide particles, as mentioned above, can be reduced to form elemental iron in Stage 2 in this environment. Or, for example, as mentioned above, an alloy comprising nickel and iron (e.g., tetrataenite), or nickel/iron/phosphorous can be formed via a complex plasma produced in Stage 1. As an alternative process, Ni nanoparticles can be coated with Fe(OH)₂, sprayed into the hot jet emerging from Stage 1, and consolidated as the soluble Fe(OH)₂ breaks down into Fe and H₂O, whereupon Ni and Fe form the desired alloy. In such a heat-focused process, the thermal energy produced by Stage 1 drives the formation of the Ni/Fe alloy. Other reactions involving particulate matter, similar to those described for Stage 1, can be produced in Stage 2 as heat-focused derivative reactions, also taking advantage of the reducing environment produced by the presence of the syngas from Stage 1. Other examples can be envisioned by skilled artisans, to be developed using no more than routine experimentation.

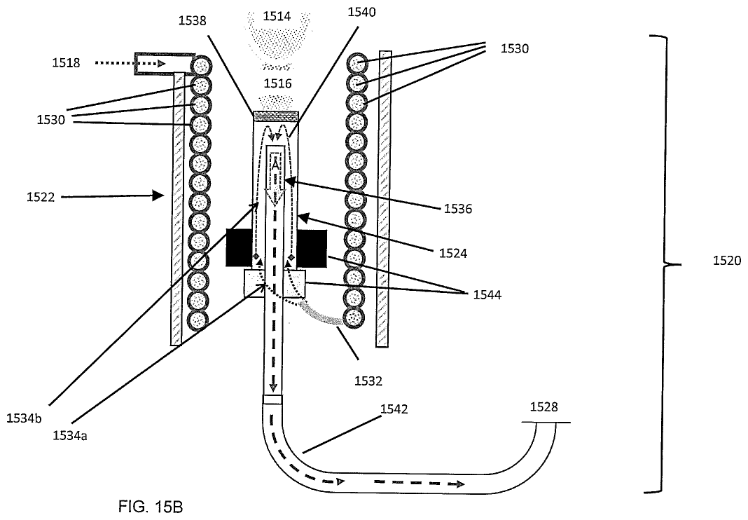

Recognizing that Stage 1 reaction products can be present in Stage 2, along with the heat that is produced by Stage 1 that is directed into Stage 2, separation mechanisms can be provided to isolate the reaction target for the heat-focused derivative reactions from the chemical products of Stage 1, so that the heat-focused derivative reactions proceed only as heat-focused derivative reactions without involving any of the Stage 1 chemical products A separation mechanism can isolate the reaction target for the heat-focused derivative reaction from any Stage 1 chemical products, for example by introducing the reaction target into a self-contained heating chamber, wherein the reaction target can be subjected to the heat energy in Stage 2 while remaining isolated from the chemical environment in Stage 2. Flow patterns for the reaction target within the self-contained heating chamber can be engineered to optimize the exposure of the reaction target to the desired amount of heat energy, with an inflow of reaction target and outflow of products derived therefrom further engineered to maximize the formation desired secondary products from the reaction target. An embodiment of an exemplary separation mechanism for a heat-focused derivative reaction is described below in conjunction with FIGS. 15A and 15B.

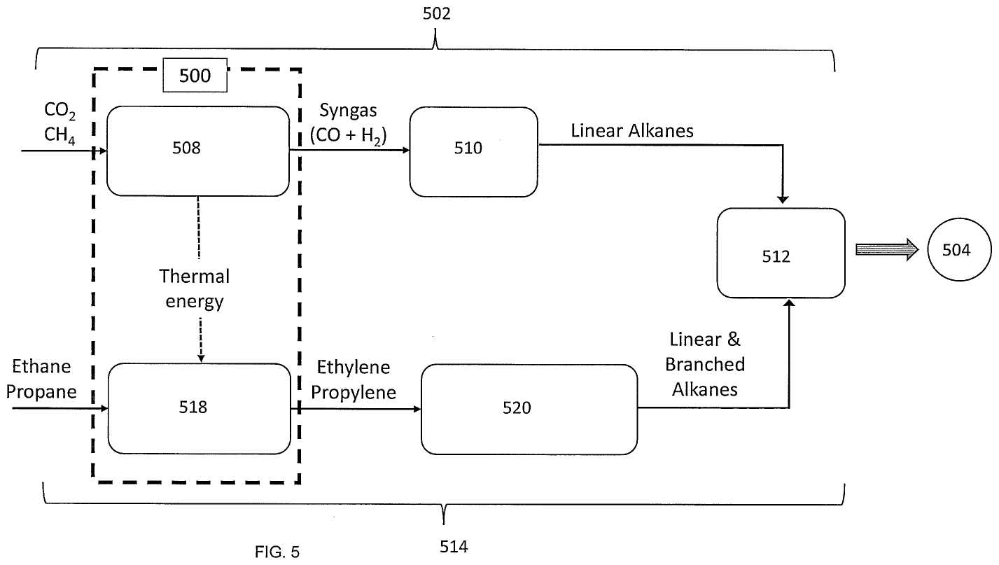

In other embodiments, the inventive systems and methods can be used to produce Stage 1 reaction products as well as Stage 2, heat-focused derivative reactions. Stage 1 and Stage 2 thus provide alternative pathways for producing the same end product. This versatility is illustrated schematically in FIG. 5, which illustrates two tertiary reaction paths for producing a synthetic kerosene or similar hydrocarbon blend that can be used as sustainable aviation fuel (SAF); either of the illustrated reaction paths can be pursued to form components that can be processed to yield SAF. As shown in FIG. 5, an embodiment of a plasma-based system 500 as described herein is depicted schematically, comprising a Stage 1 reactor 508 and a Stage 2 reaction system 518. In the depicted embodiment, CO₂ and CH₄ are primary reactants in the feedgas for Stage 1. In the depicted embodiment, the plasma reactor in Stage 1 508 produces a high purity syngas (CO and H₂), substantially free of contaminants. The pathway for using syngas to produce SAF (the “Stage 1 pathway) is designated 502. In the Stage 1 pathway 502, the syngas from Stage 1 508 can be directed into a Fischer-Tropsch reactor 510, which uses the syngas components CO and H₂ to synthesize derivative products comprising linear alkanes. These Fischer-Tropsch reaction products are then processed by a refiner 510 to yield a selected product mix, such as the one that is desirable for forming SAF 504. An alternative pathway, using thermal energy to produce SAF (the “the Stage 2 pathway), is designated 514. In the Stage 2 pathway 514, thermal energy produced by the plasma reactor in Stage 1 508 enters Stage 2 reaction system 518 to be employed in heat-focused derivative reaction involving alkanes such as ethane and/or propane that produce alkenes such as ethylene and propylene. These alkenes can then be processed in an oligomerization reactor 520 to form linear and branched alkanes. These oligomerization reaction products are then processed by a refiner 510 to form SAF 504.

b. Chemical-Focused Derivative Reactions

Chemical-focused derivative reactions either use the products of the plasma reaction itself to form other chemical products without the addition of other secondary reactants, or they combine the chemical products of the plasma reaction with secondary reactants to form desired secondary products. Chemical-focused derivative reactions using the systems and methods disclosed herein offer alternatives to a number of conventional reaction schemes that employ catalysts. For example, carbon monoxide and water can combine conventionally with acetylene via Reppe chemistry using a Ni(CO)+catalyst to form acrylic acid. Using the systems and methods disclosed herein, the carbon monoxide in the syngas can be combined with water and with acetylene (optionally produced by a heat-focused derivative reaction in Stage 2), to yield the same product. Similarly, methanol, which can be produced conventionally by combining carbon monoxide and hydrogen in the presence of a CuₓZn_{y}O catalyst, can be synthesized from the carbon monoxide and hydrogen contained in the syngas produced by the inventive systems and methods. In embodiments, the systems and methods disclosed herein can carry out certain chemically-focused derivative reactions without requiring the presence of a catalyst.

Other examples of chemical-focused derivative reactions include carbonyl insertion to make aldehydes analogous to the Gattermann-Koch reaction, hydroformylation, and oxygenation of secondary hydrocarbon reactants. Unlike their current industrial counterparts, these reactions would be driven by energetic/excited carbon monoxide (and hydrogen) molecules emanating from the plasma and can thus be accomplished without the use of catalysts. Exemplary instances include CO insertion into benzene to make benzaldehyde and hydroformylation of propylene to make butyraldehyde.

A wide range of secondary reactants can be used in chemical-focused derivative reactions. Examples of secondary reactants include, without limitation, aliphatic or aromatic hydrocarbons, including without limitation alkanes or paraffins of various sizes and structures, such as methane (CH₄), ethane (C₂H₆), propane (C₃H₈), butane (C₄H₁₀); pentane (C₅H₁₂), hexane (C₆H₁₄), heptane (C₇H₁₆), octane (C₈H₁₈), C₉-C₁₆ alkanes, or heavier molecules, and unsaturated compounds such as alkenes, alkynes, and aromatics, and including heteroatoms such as oxygen, nitrogen, or sulfur. In embodiments, exemplary secondary reactants such as alkanes (e.g., ethane, propane, butane), and aromatics such as ethylbenzene can be employed.

Secondary reactants can be introduced into the secondary reaction zone by an injector suitable for delivering the reactant in an appropriate state, whether gaseous, liquid, or solid. For derivative reactions involving liquid secondary reactants, these can be introduced to the reaction zone via an atomized spray of fine droplets. Conventional atomization techniques can be used to generate these sprays. For derivative reactions involving solid secondary reactants, these can be introduced into the reaction zone via an aerosol of particulate matter. A variety of injectors and injection techniques for secondary reactants will be familiar to artisans in the field. In a preferred embodiment, the derivative reactions in accordance with the present invention take place in continuity with the primary plasma-based reactions for producing syngas, so that the reaction products of the plasma reaction system enter directly into the derivative reactions without being removed from the system.

e. Combined Derivative Reactions

While many Stage 2 reactions can be categorized as either heat-focused or chemical-focused, certain Stage 2 reactions employ both mechanisms. In embodiments, chemical-focused derivative reactions as described above also can employ the heat energy generated by the plasma to accelerate these derivative reactions. In other embodiments, a chemical product of the primary reaction can be used in combination with the thermal energy produced by the primary reaction to produce a reaction without involving a secondary reactant.

As an example of these combined derivative reactions, a complex plasma produced in Stage 1 can yield particles that have been subjected to the plasma and that are suitable for further treatment in Stage 2. The Stage 2 treatment can involve directing the Stage 1 particles to interact with a secondary reactant in Stage 2, which can further modify the Stage 1 particles to have advantageous properties or to enter into advantageous reactions. Such a reaction can be seen when iron oxide (rust) particles are introduced into the Stage 1 plasma, which is a reducing plasma; in this environment, the iron oxide particles are chemically reduced to form elemental iron. As the hot iron particles are delivered out of the plasma reactor into the Stage 2 environment, a hydrocarbon layer can be deposited on their surfaces via contact with a secondary reactant that deposits, e.g., a graphitic outer layer on the particles. Other types of particles, including without limitation metallic microparticles or nanoparticles such as silver and copper, can be used similarly. In embodiments, the particles to be treated with the secondary reactant can be injected directly into the Stage 2 environment, benefiting from the heat of the Stage 1 reaction. However, by heating the particles in the Stage 1 plasma, their geometry and their morphology can be improved, and they can be heated to a higher temperature, all of which can improve their properties after they are coated with the secondary reactant.

In embodiments, pyrolytic processes using the systems and methods disclosed herein can be used to make valuable carbon solids such as graphene, carbon nanotubes, fullerenes, activated carbon and related materials such as biochar, charcoal, and the like, and various grades of carbon black (e.g., acetylene black, tire black). In embodiments, such carbon solids can be formed in the Stage 1 process as products of the CO₂/hydrocarbon plasma, and can then act as seeds or nucleation points for further particle growth in Stage 2. In other embodiments, the carbon particles can be added as additive particles to the reactor effluent as it emerges from Stage 1 to enter Stage 2, and such carbon particles can act as seeds or nucleation points for formation or further growth of carbon solids in Stage 2 (whether structured or unstructured, organized, amorphous, disorganized or otherwise). In yet other embodiments, the additive particles added to the reactor effluent can be non-carbon (structured or unstructured) particles that can be treated or coated with other materials to form composite particles useful for specific purposes (e.g. optoelectronics, energy storage and the like).

It is understood that further steps can be involved in order to form specific products from these derivative reactions. For example, to aid in forming carbon particles with a desired morphology and properties, small amounts of seed particles can be co-fed into the system in order to control the growth of the larger carbon particle product and protect it from the decomposition undergone by the hydrocarbon feedstock. Such seeds can comprise carbon-based, metal-based, or other organic or inorganic particulate matter in any appropriate solid form (nanoscale or macroscale, structured or amorphous), depending on the end-product desired.

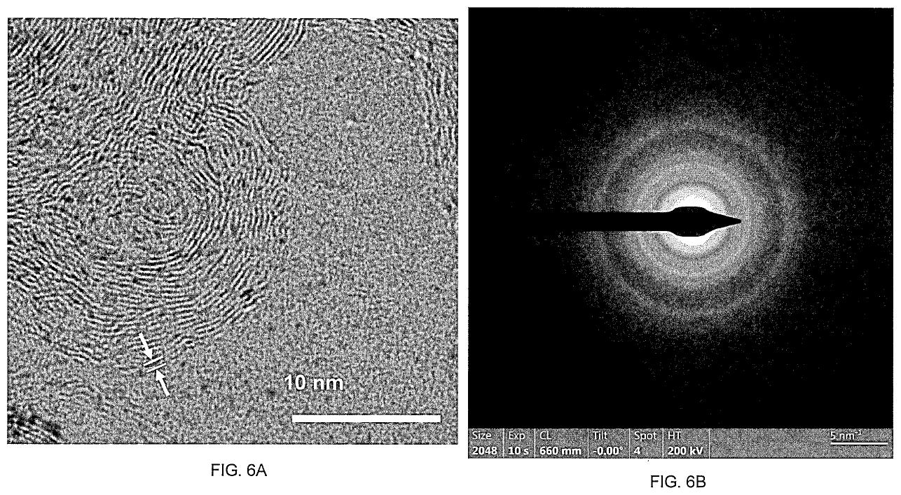

In more detail, in the case of nanotubes, one or more nucleation points, such as metallic surfaces, nozzles, sheets, meshes, nanostructured materials, and the like, can be provided downstream from the plasma outlet to instigate and propagate the growth of these nanostructured materials. FIG. 6A is a transmission electron micrograph (TEM) showing a nanoparticle synthesized by the systems and methods disclosed herein that can act as a nucleation point for further growth. This Figure also shows in more detail the fringing between graphitic layers (graphene-graphene layers ˜0.36 nm). FIG. 6B shows a TEM diffraction pattern demonstrating pure graphitic planes via the relative distance between bands.

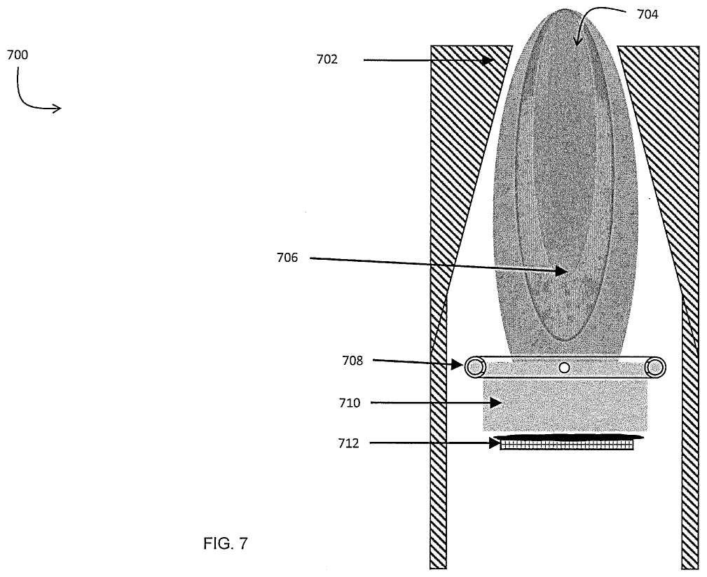

FIG. 7 depicts schematically a system 700 for using plasma-induced heated gas, external chemicals or more complex substances introduced into the system to be acted upon by the thermal energy in the heated gas (i.e., reaction targets), and nucleation sites to prepare solids of different shapes and sizes. As shown in this Figure, a plasma exhaust stream 704 exits the plasma reactor (not shown) through an exhaust nozzle 702, such as a converging-diverging nozzle, to form a post-plasma thermal plume 706 that passes through a reaction target inlet 708, here shown as a structure arranged circumferentially around the post-plasma thermal plume 706, although other arrangements of the reaction target inlet 708 in relation to the post-plasma thermal plume 706 are also consistent with the principles of the invention. Passing through the secondary reactor inlet 708, the post-plasma thermal plume 706 encounters a spray or other diffusion of a reaction target 710. The mixture of the post-plasma thermal plume 706 and the reaction target 710 is then directed to encounter one or more nucleation sites 712 that are typically metallic, but in embodiments can be formed from other suitable materials such as ceramics. Although represented here schematically as a mesh supporting a single surface, the nucleation site(s) 712 can be configured as a simple surface, a textured or structured surface, a mesh, an ordered array of surfaces, a complex geometry, or any other shape or arrangement. Moreover, the nucleation site(s) 712 need not be planar in shape, but can be shaped, curved, spherical, irregularly shaped or otherwise arranged in a solid or hollow three-dimensional structure that provides appropriate foci for nucleation of the organized solids being prepared.

The organized solids of different shapes and sizes described in conjunction with FIG. 7 can be formed, for example, in geometries ranging from carbon nanotubes to multiwalled carbon nanofibers of varying thicknesses and lengths. FIGS. 8A-C (described below) provide illustrative examples of the organized structures for such materials.

FIG. 8A is a TEM micrograph showing large-diameter (for example, having diameters between about 26 nm to about 400 nm) carbon nanotubes and nanofibers made using post-plasma thermal decomposition of reaction target gases, according to the systems and methods disclosed herein. The nanotubes thus formed vary in length and can have lengths greater than about 5 μm. FIG. 8B is a TEM micrograph showing a longitudinal cross-section of a synthesized carbon nanomaterial made using post-plasma thermal decomposition of reaction target gases, according to the systems and methods disclosed herein, demonstrating its hollow structure. FIG. 8C shows a zoomed-in portion of the micrograph of FIG. 8B, demonstrating the layered graphitic composition of the wall of the structure in FIG. 8B, and showing some fringing around the graphite layers of that wall. Without being bound by theory, it is understood that the presence of fringing is due to the bending of the electron beam captured in the TEM, visually differentiating the multiple layers of graphene in the material; fringing thus confirm the graphitization of the material, indicating that an ordered graphitic material has been formed and not a lower quality amorphous carbon. In embodiments, the system depicted in FIG. 7 (as described above) can yield organized solids that are substantially chemically uniform, as exemplified by the materials shown in FIGS. 8A-C.

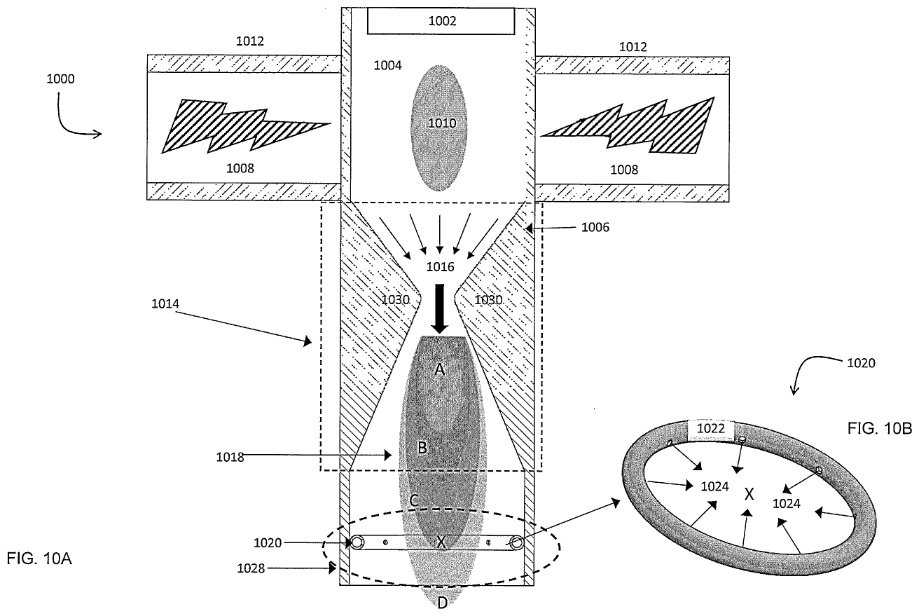

In other embodiments of the systems and methods disclosed herein, the thermal decomposition of precursor gases using post-plasma remnant heat can enable the formation of a coating chemically attached to the surface of a previously synthesized solid. For example, in accordance with these systems and methods, a carbon nanomaterial coating can be formed on a carbonaceous or non-carbonaceous particulate nucleus, as shown schematically in FIG. 9. If a silicon nanoparticle is selected as the nucleus to be coated, for example, a carbon-encased silicon material would be formed. Other composite structures having a carbon coating on a carbonaceous or non-carbonaceous nucleus can be formed using the systems and methods disclosed herein by using other carbonaceous or non-carbonaceous nuclei, for example producing shells for core-shell structures to improve functional stability, or to provide surface passivation, or to add other functionalities.

In more detail, FIG. 9 depicts a system 900 suitable for applying a carbon coating to a carbonaceous or non-carbonaceous particulate nucleus (shown representatively as 920), forming a composite structure (shown representatively at 922 and 924). As shown in FIG. 9, a plasma exhaust stream 904 exits the plasma reactor (not shown) through an exhaust nozzle 902, such as a converging-diverging nozzle, to form a post-plasma thermal plume 906 that passes through a reaction target inlet 908, here shown as arranged circumferentially around the post-plasma thermal plume 906 similar to the arrangement shown in FIG. 7 (described above), although other arrangements of the reaction target inlet 908 in relation to the post-plasma thermal plume 906 are also consistent with the principles of the invention. Entrained in the post-plasma thermal plume 906 are particulate nanomaterial nuclei (shown representatively at 920). Passing through the secondary reactor inlet 908, the post-plasma thermal plume 906 encounters a spray 910 or other diffusion of a reaction target that encounters the particulate nanomaterial nuclei 920 and forms a coating chemically attached to the surface of these previously synthesized solids 920. As shown schematically in FIG. 9, the reaction target spray 910 in contact with the particulate nanomaterial nuclei 920 can form partially coated nanomaterials 922, which can progress through the remaining available reaction target spray 912 to form the fully coated nanomaterials 924, which can then continue to flow through and exit the reactor outlet channel 914. In the depicted embodiment, the reaction target spray 912 decomposes or otherwise becomes attenuated, thereby controlling the thickness of the coating that is applied to the fully coated nanomaterials 924. Using the process represented schematically in FIG. 9, a carbon coating can be applied to a nanoparticle 920 such as a silicon nanoparticle, to form a coated nanomaterial 924 that is a carbon-encased silicon material. In addition, other solid substrates (not shown) such as carbon solids, organic polymers, metals, metal oxides, and the like can be placed downstream of the plasma to be coated by the decomposing reaction target 912.

It is understood that both organic and inorganic solids and coated nanoparticles can be produced using the systems and methods disclosed herein, both through solid nucleation in Stage 1 and material growth in Stage 2. In an exemplary practice of the inventive methods, solids or coated solids comprising silicon can be formed. For example, silicon or silica (SiO₂) nanoparticles can be formed by the decomposition of various gaseous or volatile liquid silicon-based precursors such as silane (SiH₄), trichlorosilane (SiHCl₃), dichlorosilane (SiH₂Cl₂), and tetraethylorthosilicate (TEOS, (Si(OC₂H₅)₄)). Similarly, other inorganic precursors can be used for forming particulate nanomaterials for coating (following the principles illustrated in FIG. 9) or for forming organized solids (following the principles illustrated in FIG. 7). In either case, the heat from the plasma is responsible for activating and fragmenting the reaction target that forms the desired materials. Further tunability, for example to form a composite or coated nanomaterial, can be achieved by tuning the injection mechanisms for the composite components into the system, such as the distance of the injection from the plasma, the number of nozzles employed, the nozzle diameter, the flow velocity for introducing the components into the post-plasma thermal plume, and the like.

d. Systems for Derivative Reactions

The production of derivative reactions, as described above, is an optional extension of the technologies for the plasma-driven formation of syngas as disclosed herein. These derivative reactions, however, offer an additional dimension to these systems and methods, offering an efficient, all-in-one scheme for producing commercially valuable chemicals while at the same time capturing and utilizing two greenhouse gases, methane and CO₂.

Derivative reactions are particularly favorable in these systems because the plasma reaction generates considerable heat which can be used to energize other chemical reactions. As described above, CO₂ along with methane are the primary reactants for the formation of syngas in accordance with these systems and methods. High temperatures are required in the plasma to initiate CO₂ breakdown; temperatures in the range of 5000K have been measured in the system. As described above, this excessive heat can itself be exploited for further use to energize derivative reactions.

Both heat-focused and chemical-focused derivative reactions can thus benefit from the heat energy that the plasma produces. Derivative reactions can be further facilitated by shielding the external reactant from exposure to the plasma itself, so that only the heat from the reactor and not the energy of the plasma itself can encounter the external reactant and/or energizes the derivative reaction involving the external reactant. While, in embodiments, an external reactant can be energized in its own separate plasma reactor prior to being used in a derivative reaction, in preferred embodiments the external reactant is presented in its natural state without exposure to any plasma energization.

To optimize the availability of the plasma reaction products and produced heat for derivative reactions, the product stream in embodiments can be shaped in a specific flow pattern. It has been unexpectedly discovered that shaping the effluent in a jet configuration optimizes the central localization of the reaction products to make them available for recovery or for derivative reactions, while allowing for a programmed distribution of thermal energy so that it cools sufficiently to be used in desired derivative reactions. A shape-forming structure such as a jet-producing nozzle can be integrated in the outflow tract to shape the gaseous outflow stream. In embodiments, the energized effluent from the plasma reactor is shaped as a jet within the outflow tract of the reactor (in embodiments a supersonic jet, and in other embodiments a subsonic jet) by directing the energized effluent through a shape-forming structure such as a jet-producing nozzle, e.g., a converging-diverging nozzle. The jet-producing nozzle assists in regulating the temperature of the effluent flow and shapes it for interacting with those secondary reactants or reaction targets that will be involved in the derivative reactions. Various configurations for the jet-producing nozzle can be utilized to shape the effluent stream for use in derivative reactions, to achieve the two-fold goal of presenting the reaction products from the plasma reactor for recovery or use in derivative reactions, and optimizing the amount of heat that is available for the derivative reactions. As examples, nozzle shapes can be engineered to control the pressure of the effluent streams as they exit the reactor and enter into a region for derivative reactions. An under-expanded nozzle can create an exhaust plume having a higher pressure than the pressure in the region for derivative reactions; an overexpanded nozzle can create an exhaust plume having a lower pressure than the pressure in the region for derivative reactions; and an ambient nozzle can create an exhaust plume having a pressure that equals that in the region for derivative reactions. In embodiments, the nozzle can contain a plurality of smaller openings to convert the plasma effluent into a plurality of jets. The jet-producing nozzle can also be engineered to prevent backflow from gases and vaporized liquids injected downstream of the plasma.

Additional modifications of the system can be introduced if solids or liquids are used as reaction targets for heat-focused derivative reactions, for example, using techniques familiar to skilled artisans for dispersing and delivering such materials. Exemplary potential reaction targets include polymers or macromolecules that are in a solid state, and that require specific methods for introducing them into the hot effluent produced by the syngas-forming plasma. In embodiments, these solids can be formed into a fine powder by standard methods such as grinding or spray-drying, which can then be fed directly into the plasma effluent. In other embodiments, the powder can be introduced in its native state. The introduction of powder into the hot plasma effluent can be carried out by techniques known in the art. As one example, a fluidized bed reactor can be used, in which the plasma effluent is directed vertically upward to keep the solid particles buoyant in the effluent stream long enough to react. As another example, the powdered solid material can be introduced via a hopper positioned above a horizontal plasma effluent. As another example, the powder can be placed on a conveyor belt or screw feeder that is positioned under a downward flowing plasma effluent. In other embodiments, the solids can also be dispersed or dissolved in a liquid carrier, atomized, and sprayed into the plasma effluent. Liquid polymers and macromolecules serving as reaction targets can be injected into the hot effluent via spray atomization to produce high surface area droplets.

The temperature profile experienced by the material used as a reaction target can be varied in order to influence the product composition obtained from the heat-focused derivative reaction. The systems disclosed herein are highly tunable, enabling fine tuning of the temperature profile for either solid or liquid reaction targets. Functional parameters such as the position of solids introduction, particle size, residence time in the effluent, flow pattern of the plasma effluent, and number of exposures to the plasma effluent can all be adjusted to achieve the desired product profile.

In embodiments, configurations and features of exemplary systems and methods for producing syngas and its derivatives are shown in the Figures below.

As mentioned previously, the system 100 depicted schematically in FIG. 1 for producing the chemical reactions from the hydrocarbon-containing and carbon-dioxide-containing feedgases can advantageously utilize microwaves to produce the non-thermal plasma that energizes the reactions. An exemplary reactor employing microwaves that can be used in such a system is depicted schematically in FIG. 10A.

FIG. 10A depicts schematically in longitudinal cross-section an embodiment of a reaction system 1000 comprising: an injector 1002 for introducing reactant gases (reactant gases not shown) into the plasma reactor chamber 1004; a plasma reactor chamber 1004 energized by microwave energy 1008 that generates a non-thermal plasma 1010 from the reactant gases; a waveguide 1012 for delivering the microwave energy 1008 into the plasma reactor chamber 1004; and an outflow tract 1014 for conducting a gaseous outflow stream that is a jet (a supersonic or subsonic jet) 1018 of hot ionized gas out of the reaction chamber 1004, where such jet 1018 contains the primary reaction products 1016 formed in the non-thermal plasma and further contains thermal energy produced by the non-thermal plasma. A key structural feature within the depicted outflow tract 1014 is the converging-diverging nozzle (CDN) 1030 located at the proximal end of the outflow tract 1014, through which the primary reaction products 1016 and accompanying thermal energy exit the reactor chamber 1004. As depicted in this Figure, the CDN 1030 represents a constricted tube, here shown with symmetrical constriction and expansion to provide symmetrical convergence and divergence; however, it is understood that the convergence and divergence in the nozzle need not be symmetrical, but rather can be engineered symmetrically or asymmetrically to produce the desired features of stream flow for the jet 1018 for example, in embodiments, laminar flow and desired pressure, velocity, and temperature arrangements in the jet 1018. In this Figure, the CDN 1030 is shown as a formation of the interior wall of the housing 1006, where the housing 1006 is a single structure encasing the plasma chamber 1004 and the outflow tract 1014. Other arrangements for the CDN are readily envisioned in which the CDN is not formed from a portion of the housing 1006.

As shown in the embodiment schematically represented in FIG. 10A, the jet 1018 is not uniform in its distribution of reaction products or thermal energy. As shown, the more proximal area A of the jet 1018 contains more heat, while the heat decreases in the more distal portions B, C, D of the jet 1018. Areas A through D on the Figure are not intended to represent discrete demarcations in heat levels within the jet, but rather serve to indicate that there is a continuum of heat energy from proximal to distal, and from central to peripheral in the jet 1018. Similarly, the types and amounts of reaction products can vary within the jet 1018 ranging from proximal to distal and/or ranging from central to peripheral in their distribution.

As shown in FIG. 10A, the primary reaction products 1016 and thermal energy within the jet 1018 can be used to generate derivative reactions involving secondary reactants in a chemical-focused derivative reaction (a secondary reaction). In the depicted embodiment, a source 1020 of secondary reactants can be positioned at a selected location with respect to the jet 1018; here a source 1020 of secondary reactants is shown positioned toward the distal end of the jet 1018. This structure 1020 delivers secondary reactants into the selected location X of the jet 1018 that serves as the secondary reaction zone, so that the secondary reactants can interact in the secondary reaction zone X with the certain of the reaction products 1016 from the primary plasma-based reactions, thereby producing one or more desired secondary (i.e., chemical-focused derivative) reactions and secondary reaction products. Moreover, the heat carried by the jet 1018 can be used to energize the secondary reactions, to enhance their efficiency, to improve their selectivity, or the like, as would be understood by practitioners of ordinary skill in the art. In embodiments, the secondary reactants can be energized by a separate, external plasma system (not shown) and delivered into the secondary reaction zone X, so that activated species are produced from the secondary reactants to interact with the primary reaction products 1016.

The depicted source 1020 of secondary reactants is shown in more detail in FIG. 10B. FIG. 10B shows the source 1020 of secondary reactants configured as an injector for gases having an injector ring 1022, in which the entry orifices (not shown) for the secondary reactant gases are situated on the internal aspect of the injector ring 1022, with the gases 1024 being directed centrally to enter the secondary reaction zone X. While the secondary reaction zone is represented by a limited region X, it is understood that a larger region for secondary reactions 1028 is available, as shown in FIG. 10A. Secondary reaction products that are formed in the secondary reaction zone X and/or in the larger region for secondary reactions 1028 can be retrieved using conventional methods, and/or can exit the distal portion of the system 1000; in embodiments the products of the secondary reactions can be entrained in the exhaust from the jet 1018 such as is found at level D in the jet 1018.

While FIG. 10A shows primary reaction products 1016 being directed into the secondary reaction zone X along with thermal energy within the jet 1018, with the primary reaction products 1016 encountering the secondary reactants to produce secondary reaction products in a chemical-focused reaction, heat-focused derivative reactions are also possible, although not specifically shown in this Figure. A heat-focused derivative reaction takes place in a derivative reaction zone appropriate for heat-focused derivative reactions, or in a larger region for heat-focused derivative reactions. In a heat-focused derivative reaction, the primary reaction products can be separated from the thermal energy produced by the primary reaction, with the thermal energy being directed into a heat-focused derivative reaction zone to encounter an externally-provided reactant, i.e., a reaction target. In such an embodiment, the thermal energy energizes the reaction target to undergo the heat-focused derivative reaction, yielding derivative reaction products.

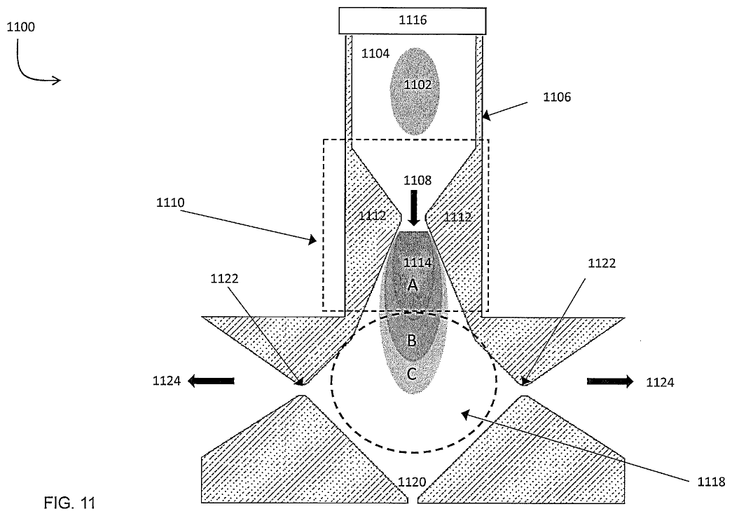

FIG. 11 depicts schematically in longitudinal cross-section another embodiment of a reaction system 1100 for producing derivative reactions from the hydrocarbon-containing and carbon-dioxide-containing feedgases. As shown in FIG. 11, a plasma 1102 is formed in a plasma reaction chamber 1104 from feedstock gases (not shown) that are introduced through an injector such as the gas injector 1116, using energy sources (not shown) substantially similar to those described above. The plasma 1102 generates a number of primary reaction products 1108 that exit the reaction chamber 1104 to enter the outflow tract 1110. In the depicted embodiment, the outflow tract 1110 comprises a longitudinally oriented CDN 1112 that directs the primary reaction products 1108 and accompanying thermal energy to form a jet (a supersonic or subsonic jet) 1114 that propagates distally. The CDN 1112 is shown as a formation of the interior wall of the housing 1106, where the housing 1106 is a single structure encasing the plasma chamber 1104 and the outflow tract 1110. Other arrangements for the CDN are readily envisioned in which the CDN is not formed from a portion of the housing 1106.

As the jet 1114 passes distally, its composition changes and its temperature decreases, as represented by the different levels A-B-C. As in the previous Figure, areas A through C in this Figure are not intended to represent discrete demarcations in heat levels within the jet, but rather serve to indicate that there is a continuum of heat energy from proximal to distal and from central to peripheral within the jet 1114. Similarly, the types and amounts of reaction products 1108 can vary within the jet 1114 ranging from proximal to distal and/or ranging from central to peripheral in their distribution. The distal portion of the jet 1114 (corresponding to levels B and C in this Figure for exemplary purposes) enters a region for secondary reactions 1118, where the distal portion of the jet 1114 encounters one or more secondary reactants instilled into this region 1118 through a secondary injector port 1120, shown here as located distally. Deployed circumferentially around the region for secondary reactions 1118 is an azimuthally symmetric CDN 1122 that permits the efflux 1124 of secondary reaction products and/or exhaust. While the CDN 1122 is depicted as a formation of the interior wall of the housing 1106, it is understood that other arrangements for the CDN are readily envisioned, in which the CDN is not formed from a portion of the housing 1106.

While FIG. 11 shows primary reaction products 1108 being directed into the region for secondary reactions 1118 along with thermal energy within the jet 1114, with the primary reaction products 1108 encountering the secondary reactants to produce secondary reaction products in a chemical-focused reaction, heat-focused derivative reactions are also possible, although not specifically shown in this Figure. As mentioned previously, in connection with the description of FIG. 10, such a heat-focused derivative reaction takes place in a derivative reaction zone appropriate for heat-focused derivative reactions, or in a larger region for heat-focused derivative reactions. In a heat-focused derivative reaction, the primary reaction products 1108 can be separated from the thermal energy produced by the primary reaction, with the thermal energy being directed into a heat-focused derivative reaction zone to encounter an externally-provided reactant, i.e., a reaction target. In such an embodiment, the thermal energy energizes the reaction target to undergo the heat-focused derivative reaction, yielding derivative reaction products.

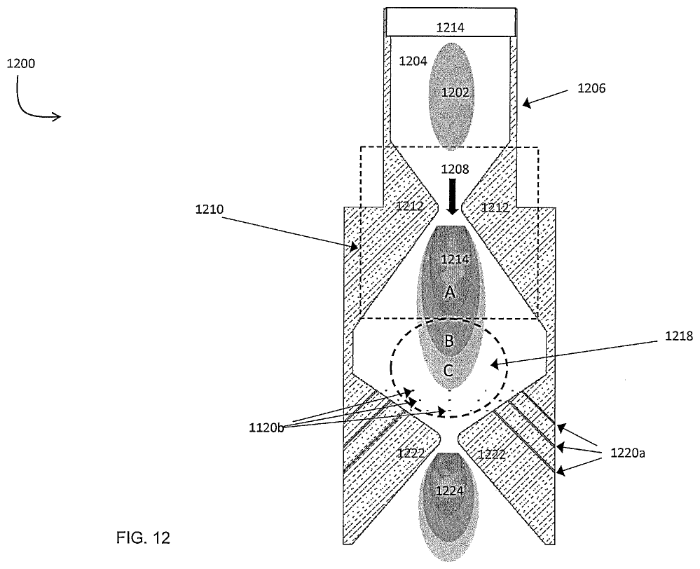

FIG. 12 depicts schematically in longitudinal cross-section yet another embodiment of a reaction system 1200 for producing derivative reactions from the hydrocarbon-containing and carbon-dioxide-containing feedgases. As shown in FIG. 12, a plasma 1202 is produced in a reaction chamber 1204 from feedstock gases that are introduced through an injector such as the gas injector 1214, using energy sources (not shown) substantially similar to those described above. The plasma 1202 generates a number of primary reaction products 1208 that exit the reaction chamber 1204 to enter the outflow tract 1210. In the depicted embodiment, the outflow tract 1210 comprises a longitudinally oriented CDN 1212 that directs the primary reaction products 1208 and accompanying thermal energy to form a jet 1214 that propagates distally. In this Figure, the CDN 1212 is shown as a formation of the interior of the housing 1206, where the housing 1206 is a single structure encasing the plasma chamber 1204 and the outflow jet 1214. Other arrangements for the CDN are readily envisioned in which the CDN is not formed from a portion of the housing 1206. As the jet 1214 passes distally, its composition changes and its temperature decreases, as represented by the different levels A-B-C. As in the previous Figure, areas A through C in this Figure are not intended to represent discrete demarcations in heat levels within the jet 1214, but rather serve to indicate that there is a continuum of heat energy from proximal to distal, and from central to peripheral in the jet 1214. Similarly, the types and amounts of reaction products can vary within the jet 1214 ranging from proximal to distal and/or ranging from central to peripheral in their distribution. The distal portion of the jet 1214 (corresponding to levels B and C in this Figure for exemplary purposes) enters a region for secondary reactions 1218, where the distal portion of the jet 1214 encounters one or more secondary reactants instilled through a plurality of secondary injector ports distal to the region for secondary reactions 1218, shown in longitudinal section as 1220a and shown as entry orifices 1220b. While the plurality of secondary injector ports 1220a and 1220b are shown in this Figure as distributed relatively uniformly along the interior of the housing 1206 distal to the region for secondary reactions 1218, they can be arranged in any position distal to or parallel to the distal portion of the jet 1214 so that the reaction products and heat contained in the jet 1214 can interact with the secondary reactants being dispensed through the injector ports 1220a and 1220b. Distal to the region for secondary reactions is an exhaust CDN 1222 that permits the efflux 1224 of secondary reaction products.

While FIG. 12 shows primary reaction products 1208 being directed into the region for secondary reactions 1218 along with thermal energy within the jet 1214, with the primary reaction products 1208 encountering the secondary reactants to produce secondary reaction products in a chemical-focused reaction, heat-focused derivative reactions are also possible, although not specifically shown in this Figure. As was described in connection with FIGS. 11 and 12, a heat-focused derivative reaction takes place in a derivative reaction zone appropriate for heat-focused derivative reactions, or in a larger region for heat-focused derivative reactions. In a heat-focused derivative reaction, the primary reaction products 1208 can be separated from the thermal energy produced by the primary reaction, with the thermal energy being directed into a reaction zone to encounter an externally-provided reactant, i.e., a reaction target. In such an embodiment, the thermal energy energizes the reaction target to undergo the heat-focused derivative reaction, yielding derivative reaction products.

The foregoing FIGS. 10-12 depict embodiments of reaction systems that produce chemical-focused derivative reactions, i.e., those in which the chemical products of the primary reaction are involved. These Figures, however, illustrate principles that can be applied to heat-focused derivative reactions as well. In each of these Figures, a jet of hot gas is shown leaving the reaction chamber and encountering external reactants (secondary reactants) in a region for secondary reactions, where the chemical-focused derivative reaction(s) take place. For an analogous heat-focused derivative reaction, the jet of hot gas can be used as a carrier for thermal energy that leaves the reaction chamber and enters a region or zone for heat-focused derivative reactions, where the thermal energy encounters an external reactant (the reaction target); the action of the thermal energy on the reaction target accomplishes the heat-focused derivative reaction. Systems for heat-focused derivative reactions can be engineered similarly to those systems depicted in FIGS. 10-12 for chemical-focused derivative reactions, employing no more than routine experimentation.

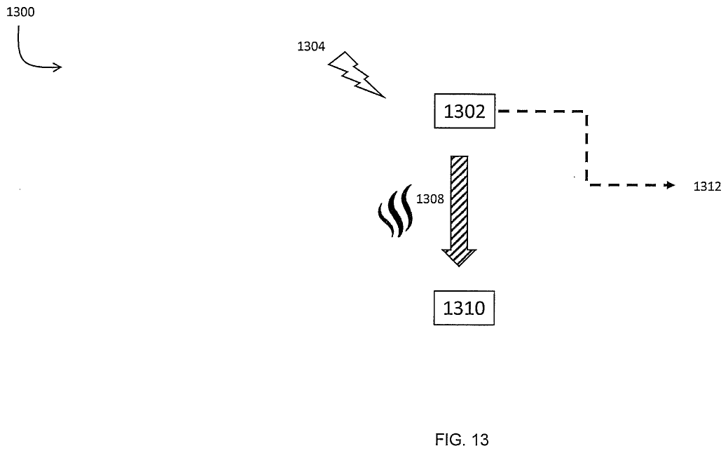

FIG. 13 provides a block diagram showing how a reaction system 1300 can produce a heat-focused derivative reaction. This Figure depicts a system 1300 comprising a first stage 1302 and a second stage 1310. The first stage 1302 is the primary plasma reaction energized by microwave energy 1304, as described above in more detail. This stage 1302 can produce syngas at a high degree of efficiency (>95% single-pass conversion). As shown in this Figure, the primary reaction products 1312 (e.g., syngas) can be removed from the system, while allowing the thermal energy 1308 produced by the plasma to be used to energize derivative reactions. The second stage 1310 represents the energization of the reaction target by this heat energy, to produce derivative reactions such as desaturation reactions (analogous to traditional “cracking” reactions), cyclization reactions, and the like. In other embodiments (not shown), the primary reaction products can remain within the system without being removed, but also without entering into the derivative reaction. Such a reaction, using only the thermal energy produced by the primary reaction but not involving the primary reaction products, would also be considered a heat-focused derivative reaction.

FIG. 14 depicts schematically an embodiment of a complete reaction system 1400 consistent with the principles of the invention. As shown in this Figure, there are system components for Stage 1 (Section A, encompassed by the bracket “A”), and system components for Stage 2 (Section B, encompassed by the bracket “B”). The system components for Stage 1 comprise a plasma chamber 1402 having a top (proximal) end 1410 and a bottom (distal) end 1408. As shown in the Figure, an inflow stream 1404 is deployed from distal 1408 to proximal 1410 within the plasma chamber 1402, in a retrograde direction 1406 (i.e., from distal to proximal) and flowing in an inflow path 1416 characterized by a vortical geometry along the periphery 1412 of the plasma chamber 1402. As the inflow stream 1404 reaches the proximal end 1410, it encounters a top barrier 1430 shaped as an inverted dome. This top barrier 1430 structure redirects and reverses the flow of the inflow stream, producing a redirected stream 1418 that proceeds in an antegrade direction (i.e., from proximal to distal) oriented centrally within the plasma chamber 1402 to be acted upon by energy source that produces the plasma (not shown). The reaction products produced within the plasma (not shown) continue distally through the central portion of the plasma chamber 1402 to exit it distally through an exit nozzle 1434, which is shaped as a converging-diverging nozzle in the depicted embodiment. The outflow products 1428 pass from the Stage 1 plasma chamber 1402 into the section of the reaction system 1400 that carries out the Stage 2 reactions. The depicted system 1400 directs the outflow products 1428 from Stage 1 into Stage 2, where they undergo chemical-focused derivative reactions. Although a variety of system components are available for producing Stage 2 reactions, as described above without limitation, the depicted embodiment shows a products spray 1438 passing into the Stage 2 reaction section, where it is contacted by a secondary reactant (not shown) injected through a set of secondary reactant nozzles 1436, here depicted as four such nozzles. The depicted embodiment thus performs a chemical-focused derivative reaction. Other embodiments of this system and the Stage 1 and Stage 2 processes can be readily envisioned that are consistent with the heat-focused and the chemical-focused reactions described above, as well as those reactions derived from the formation of a complex plasma in Stage 1.

FIG. 15A depicts schematically in longitudinal cross-section another embodiment of a reaction system 1500 for producing heat-focused derivative reactions from the hydrocarbon-containing and carbon-dioxide-containing feedgases. As shown in FIG. 15A, a plasma 1510 is produced in a reaction chamber 1502 from feedgases that are introduced through an injector (not shown) to be energized by microwave energy 1504 delivered via a waveguide 1508. After the plasma 1510 is formed, a plasma exhaust stream 1514 exits the reaction chamber 1502 through an exhaust nozzle 1512. As depicted, the exhaust nozzle 1512 is a structural feature of the housing 1506, which has been described previously as a single structure encasing the plasma chamber 1502 and the plasma chamber outflow tract (as identified in previous Figures). As has been described for nozzle configurations in previous Figures, the exhaust nozzle 1512 in this Figure can be engineered in various forms to direct the plasma exhaust stream 1514 as it exits the plasma chamber 1502 and to shape it to form the jet 1516 of ionized gas that exits the plasma chamber 1502.

The foregoing processes are Stage 1 reactions, which are understood to be those reactions involving primary reactants being energized in the plasma; Stage 1 reactions have been described in detail previously. In addition to such primary, Stage 1, reactions, this Figure depicts a heat-focused derivative reaction, also termed a Stage 2 reaction, produced outside the plasma reaction chamber 1502 using the heat energy generated by the primary reaction that has taken place in the plasma reaction chamber 1502. In more detail, FIG. 15A depicts the plasma exhaust stream 1514 passing through the exhaust nozzle 1512, which shapes the plasma exhaust stream 1514 to form a jet 1516 of hot gas, containing both the reaction products and the heat generated by the plasma. This jet 1516 includes a post-plasma thermal plume that provides the thermal energy that is captured in the thermal mediator subsystem 1520 and is transferred thereby to energize the reaction target to undergo heat-focused derivative reactions, yielding thermal derivative products.

The thermal mediator subsystem 1520 is located in Stage 2. As has been previously described, Stage 2 reactions are derivative reactions that take place outside the plasma chamber using the heat energy or the chemicals (or both) generated by the primary reaction in the plasma reaction chamber 1502. For the depicted reaction system 1500, the derivative reaction in Stage 2 is a heat-focused derivative reaction. In the depicted embodiment, the jet 1516, including the post-plasma thermal plume, exits Stage 1, and enters the thermal mediator subsystem 1520, which is situated in Stage 2, distal to and in proximity to the exhaust nozzle 1512. The heat conveyed in the jet 1516 (i.e., the post-plasma thermal plume) is trapped by the structures of the thermal mediator subsystem 1520 as described below, while any primary chemical products carried in the jet 1516 pass through the thermal mediator subsystem 1520 without affecting the derivative reactions taking place therein. The thermal mediator subsystem 1520 provides an advantageous separation mechanism within the derivative reaction zone in Stage 2 that isolates the heat-focused derivative reaction taking place therein from any chemical products from the Stage 1 reaction that may have entered Stage 2 as part of the jet 1516. To accomplish this, the thermal mediator subsystem 1520 sequesters the reaction target within a self-contained heating chamber, wherein the reaction target can be exposed to the thermal energy in Stage 2 to produce the heat-focused derivative reaction while remaining isolated from the chemical products from the Stage 1 reaction that may be present in Stage 2. As mentioned previously, flow patterns for the reaction target within the self-contained heating chamber (here, the thermal mediator subsystem 1520) can be engineered to optimize the exposure of the reaction target to the desired amount of heat energy; the inflow of external chemicals or more complex substances to be acted upon by the heat energy (i.e., the reaction targets) and outflow of products derived therefrom can be further engineered to maximize the formation of desired secondary products by the heat-focused derivative reaction.

FIG. 15A depicts an embodiment of such a self-contained heating chamber as part of a reaction system 1500; FIG. 15B show this self-contained heating chamber (here, the thermal mediator subsystem 1520) in more detail. While the thermal mediator subsystem and its components as depicted in these Figures have been described with reference to a particular heat-focused derivative reaction (here, a “cracking” reaction), it is understood that this subsystem can be employed to incite and effect a variety of heat-focused derivative reactions besides cracking. Any reaction involving the thermal mediator subsystem disclosed in these Figures is intended to proceed only as a heat-focused derivative reaction without involving any of the chemical products of Stage 1: non-limiting examples of such reactions have been disclosed herein previously. Thus any reference to “cracking” or its grammatical congeners in connection with the descriptions of FIGS. 15A and 15B is intended only to be an exemplary embodiment of a heat-focused derivative reaction, and not in any way limiting.

In the embodiment shown in FIG. 15A, the thermal mediator subsystem 1520 comprises a secondary reactor inlet 1518 through which a reaction target enters the subsystem 1520, and passes into a graphite cracking chamber 1524 to undergo heat-focused derivative reactions therein, as described in more detail below. The thermal derivative products from the heat-focused derivative reactions then exit the graphite cracking chamber 1524, passing over to an outlet 1528 through which they leave the thermal mediator subsystem 1520. As depicted in FIG. 15A, the graphite cracking chamber 1524 is positioned coaxially within an outer alumina tube 1522 that is affixed to or is contiguous with the housing 1506. In other embodiments, the graphite cracking chamber 1524 can be positioned within an extension of the housing 1506 that extends distally to surround the graphite cracking chamber 1524. Other surrounding structures can be readily envisioned that would support the graphite cracking chamber 1524 and position it appropriately to collect the heat from the post-plasma thermal plume and transfer that heat to designated reaction target.

FIG. 15B shows the thermal mediator subsystem 1520 in more detail, as a close-up of the reaction system 1500 shown in longitudinal cross-section in FIG. 15A. As shown in FIG. 15B, the thermal mediator subsystem 1520 comprises a graphite cracking chamber 1524 that transfers heat from the plasma exhaust stream 1514, and more specifically from the post-plasma thermal plume entering Stage 2, to the reaction target that is delivered into the subsystem 1520. The jet 1516 (including the post-plasma thermal plume) first encounters a graphite cap 1538 situated proximally in the thermal mediator subsystem 1520, the graphite cap 1538 traps heat carried in the post-plasma thermal plume and captures it for contacting the reaction target. The residual beat from the post-plasma thermal plume remaining after its encounter with the graphite cap 1538 then spreads throughout the thermal mediator subsystem 1520 environment, heating the other components of the subsystem 1520. Besides heating the graphite cap, the heat energy from the thermal plume heats the external aspects of the graphite cracking chamber 1524 and the coil of stainless steel surrounding it. These secondary structures assist in the overall heat transfer process from the thermal plume to the reaction target to facilitate the heat-focused derivative reactions in the graphite cracking chamber.

As further shown in FIG. 15B, the reaction target enters the subsystem 1520 through a secondary reactor inlet 1518, and passes through a coil of stainless-steel tubing 1520 positioned internal to an outer alumina tube 1522; in the depicted arrangement, the outer alumina tube 1522 forms the outer boundary of the thermal mediator subsystem 1520. The reaction target flowing within the stainless-steel tubing coil 1520 is heated by residual heat from the post-thermal plume 1516 to pre-beat it before it is delivered into the graphite cracking chamber 1524. In the depicted embodiment, the pre-heated reaction target exits the stainless-steel tubing coil 1520 through an outlet conduit 1532 that delivers it into the graphite cracking chamber 1524 along one or more flow paths 1534a, through which the pre-heated reaction target enters the graphite cracking chamber 1524. In other embodiments (not shown), the coil of stainless-steel tubing 1520 can be replaced by other tubes or coils for pre-heating, for example one or more concentric tubes within which the reaction target is heated by the residual heat from the post-thermal plume. Such heat exchanger tubes can be made of thermally resistant materials such as graphite, aluminum nitride, ceramics and the like.

The reaction target flows from distal to proximal towards the graphite cap 1538 along a laterally orientated continuation of the flow path 1534b Upon approaching the graphite cap 1538, the laterally oriented flow of the reaction target reverses longitudinal direction 1540, and is also directed centrally, to enter a collecting cylinder 1536 as shown in FIG. 15B. In the depicted embodiment, the gaseous stream containing the thermal derivative products then flows within the collecting cylinder 1536 along the path indicated by Arrow A, to exit the collecting cylinder 1536 through a cracking chamber outflow tract 1542, and to be removed from the thermal mediator subsystem through an outlet 1528. While a collecting cylinder 1536 is depicted in the embodiment shown in FIG. 15B, the collecting cylinder 1536 is optional; in those embodiments lacking a collecting cylinder 1536, the dynamics of the reversing flow 1540 can be engineered to direct the heated reactants both distally and centrally so that they exit the graphite cracking chamber 1524 along the path indicated by Arrow A through a cracking chamber outflow tract 1542, without the need for a collecting cylinder 1536 to confine the heated reactants physically.

It is understood that the exposure of the reaction target to the heat captured within the thermal mediator subsystem 1520, and particularly within the graphite cracking chamber 1524 causes the desired heat-focused derivative reaction to occur, whereby the reaction target is converted into the designated thermal derivative products. The graphite cap 1538 is particularly important in this heat transfer process because of its ability to absorb, retain, and distribute large amounts of thermal energy; without being bound by theory, it is understood that smoothing out the radial temperature profile of the pre-heated reaction target can improve the selectivity of the heat-focused derivative reactions as disclosed herein. Exposure of the reaction target to the heat absorbed by the graphite cap can of itself produce heat-focused derivative reactions; preheating the reaction target in the rest of the graphite cracking chamber 1524 and/or in the surrounding coil of stainless-steel tubing 1530 can facilitate such reactions or improve the yield of desired thermal derivative products.

A variety of materials are suitable for fabricating the various components of the thermal mediator subsystem 1520. Thermally resilient materials like graphite are advantageous for those components of the graphite cracking chamber 1524 that are exposed to heat, such as the outer wall of the graphite cracking chamber 1524 and the collecting cylinder 1536. Chosen materials for the graphite cracking chamber 1524 and its components are also desirably non-ferrous, so that graphite, aluminum nitride, and ceramics capable of sustaining high temperatures can be used. In embodiments, heat retention within the system can be improved with insulation, for example around the alumina tube within which the graphite cracking chamber 1524 is positioned.

### EXAMPLES

The exemplary embodiments are provided below to illustrate more fully the systems and methods disclosed herein.

### Example 1: Single-Stage Dry Methane Reforming with a Single Flowpath Antegrade Vortex Flow

Flows of 4 SLPM CO₂, 4 SLPM CH₄, and 8 SLPM H₂ were mixed together and sent through a vortexing nozzle with four tangential outlets into a proximal end of a quartz reactor tube. The vortexing gas was sent in an antegrade direction from proximal to distal within the quartz reactor tube, passing through a microwave-sustained plasma region. The total input microwave power was 2,000 W. The pressure inside the quartz reactor tube was maintained at or just below 1 atm. The composition of the effluent gas was analyzed by gas chromatography. The conversions were 92.2% for CO₂ and 90.3% for CH₄. The yields (based on initial CO₂ and CH₄) were 84.8% for CO, 79.3% for H₂, 2.3% for ethylene, and 4.2% for acetylene. The energy efficiency toward syngas was 28.9%.

### Example 2: Second-Stage Propane Injection into the Plasma Effluent from the Single Flowpath Antegrade Vortex Flow Setup

This Example involved two stages, Stage 1 and Stage 2. The setup and conditions for Stage 1 of this Example were identical to the setup and conditions employed in Example 1. After passing through Stage 1, the outflow products then passed into the Stage 2 setup. The Stage 2 set-up involved: (a) an insert tube positioned within the distal portion of the Stage 1 quartz reactor tube that was described in Example 1, just downstream of the outflow from Stage 1, and (b) an array of four symmetrical nozzles (“reaction target nozzles”) radially oriented and directed centrally, through which a reaction target would be injected into the plasma exhaust stream, which contained the thermal energy and the outflow products from Stage 1, with the nozzle array positioned at the top portion of the insert tube.

Using the Stage 2 apparatus, the reaction target was injected through the reaction target nozzles into the exhaust stream produced by Stage 1, encountering the exhaust stream about 6-7 cm downstream of the microwave-sustained plasma region at 2.5 SLPM. Propane was selected as the reaction target for this Example. The encounter between the thermal energy in the exhaust stream and the reaction target resulted in heat-focused derivative reactions, yielding acetylene, ethylene, ethane, and propane as derivative products. The conversions were 89.4% for CO₂, 74.9% for CH₄, and 34.2% for propane. The production rates were 6.64 SLPM CO, 6.89 SLPM H₂, 0.54 SLPM ethylene, 0.185 SLPM acetylene, 0.134 SLPM ethane, and 0.18 SLPM propylene.

### Example 3: Second-Stage Ethane Injection with Formation of Carbon Nanotubes

An experimental setup similar to the one in Example 2 was used, with the same Phase 1 set-up as in Example 2, and minor changes in the nozzle arrangement for Phase 2 as compared to the arrangement and orientation described in Example 2. Ethane was selected at the reaction target, and was injected through the reactant nozzles at various rates between 0.5 and 3.5 SLPM. After the injections took place, carbon solids were collected from the Phase 2 set-up by being manually scraped off of the injection nozzles that were used to inject the reaction target. Approximately 200 mg of carbon solids were collected. TEM imaging confirmed that the morphology of the carbon consisted of multi-walled nanotubes several micrometers in length and 100-300 nm in diameter. Exemplary images of the multiwalled nanotubes produced in this Example are shown in FIGS. 8A-C.

### Example 4: Single-Stage Dry Methane Reforming with a Dual Flowpath Reversing Vortex Flow Setup

Flows of 7 SLPM CO₂, 7 SLPM CH₄, and 14 SLPM H₂ were sent into a plasma reactor chamber through a vortexing nozzle with four tangential outlets that directed the inflow gas stream into a quartz reactor tube. The gas was injected in the distal portion of the quartz reactor tube, and then was directed retrograde in a swirling (vortical) path from distal to proximal, followed by a redirection of the vortical flow from proximal to distal when the flow reached the proximal end. The proximal end of the quartz tube was equipped with an inverted dome structure which the vortical flow from distal to proximal encountered; this encounter with the inverted dome structure resulted in the redirection of the vortical flow so that it then proceeded in an antegrade direction from proximal to distal. The plasma reaction chamber thus sustained a dual flowpath with reversing vortex flow.

As the gas followed its redirected vortical flow path in an antegrade direction from proximal to distal, it passed through a microwave-sustained plasma region. The outflow products in the exhaust emanating from the plasma region passed through a converging-diverging nozzle to exit the plasma reactor. The input microwave power was 3500 W. The pressure in the quartz tube was maintained at 0.891 atm. The composition of the effluent was analyzed by gas chromatography. The conversions were 96.0% for CO₂ and 95.4% for CH₄. The yields (based on initial CO₂ and CH₄) were 89.2% for CO, 87.6% for H₂, 1.3% for ethylene, and 5.4% for acetylene. The energy efficiency toward syngas was 31.2%.

The system used for this Example 4 is similar to the system depicted schematically as Section A of FIG. 14. As shown in that Figure and as described above, Section A illustrates system components of Stage 1; such a setup was employed in Example 4. The Figure uses a CAD simulation for Section A to show the reaction system 1400 that was used in Examples 4 and 5, with the approximate size for the Stage 1 apparatus indicated by the ruler in mm alongside the plasma chamber 1402 shown in the Figure.

### Example 5: Long-Duration Syngas Production at 5 kW

The system used for this Example is similar to the system depicted schematically as Section A in FIG. 14. At a microwave power of 5 KW, 10.8 SLPM CO₂ and 10.3 SLPM CH₄ were injected in a reverse-vortex manner. Pressure was maintained at 1 atm. The plasma was run uninterrupted for 8 hr. The composition of the effluent was analyzed by gas chromatography. Over the 8 hr, the average conversions were 97.5% for CO₂ and 99.5% for CH₄. The average yields (based on fed CO₂ and CH₄) were 97.6% for CO, 94.2% for H₂, 0.25% for ethylene, and 0.32% for acetylene. Production rates of CO and H₂ changed by less than 1% over 8 hr.

### Example 6: Second-Stage Ethane Injection into the Plasma Effluent from Reverse-Vortex Converging-Diverging Nozzle Setup

This Example involved two stages, Stage 1 and Stage 2. The setup and conditions for Stage 1 of this Example were identical to the setup and conditions employed in Example 4, and as depicted schematically in Section A of FIG. 14. As described above in Example 4, the outflow products in the exhaust stream exiting the Stage 1 plasma region passed through a converging-diverging nozzle. The exhaust stream containing the outflow products then passed into the Stage 2 setup, as depicted schematically in Section B of FIG. 14: this Figure shows schematically how the Stage 2 setup can be integrated with that of Stage 1. Furthermore, Section B of FIG. 14 schematically depicts components of the Stage 2 setup as employed in Example 5.

In more detail, the Stage 2 setup was characterized by a set of four symmetrical and radially oriented nozzles that served as reaction target inlets; these nozzles were directed centrally and positioned just downstream of the converging-diverging nozzle from Stage 1, through which a reaction target was injected into the plasma exhaust stream containing the thermal energy and outflow products from Stage 1. The reaction target inlet assembly was positioned so as to dispense the reaction target at a preselected area of the plasma exhaust stream in order to optimize the formation of desired derivative products, as schematically illustrated in FIG. 14. A spray of derivative products was formed from the encounter of the injected reaction target with the plasma exhaust stream emerging from the Stage 1 reactor.

For this Example, ethane was selected as the reaction target. The encounter between the thermal energy in the exhaust stream and the reaction target resulted in heat-focused derivative reactions, yielding acetylene and ethylene as derivative products. Ethane was injected into the exhaust stream at a total rate of 5 SLPM. Conversions were 86.0% for CO₂, 77.5% for CH₄, and 42.3% for ethane. The production rates were 11.0 SLPM CO, 12.9 SLPM H₂, 1.34 SLPM ethylene, and 0.90 SLPM acetylene.

### Example 7: Selective Ethane Cracking to Ethylene with Thermal Mediator Subsystem

This Example involved two stages, Stage 1 and Stage 2. The setup and conditions for Stage 1 of this Example were identical to those in Example 4. As described above in Example 4, the outflow products in the exhaust stream exiting the Stage 1 plasma region were then passed into the Stage 2 setup, including the heat produced in the plasma which entered Stage 2 as the post-plasma thermal plume. The Stage 2 setup featured a thermal mediator subsystem to transfer heat from the exhaust stream to a reaction target so that the heat could affect the reaction target to cause a chemical reaction; the reaction produced in this Example is termed “cracking.” The arrangement in Stage 2 for this Example is depicted schematically in FIGS. 15A and 15B, and is described above in connection with FIGS. 15A and 15B. Briefly, as shown in FIG. 15A, the thermal mediator subsystem comprised an outer alumina tube within which a coil of stainless-steel tubing was disposed, and further comprised a graphite cracking chamber arranged coaxially within the tubing. The coiled stainless-steel tubing had a proximal inlet for the entry of the reaction target and a distal outlet for the exit of the reaction target after it had been heated by its passage through the coiled stainless-steel tubing, as depicted schematically in FIG. 15B.

The reaction target used for this Example was ethane. Ethane was admitted into the proximal inlet of the stainless-steel tubing and passed through the coil from proximal to distal, wherein it was preheated by the residual heat from the hot effluent exhaust stream that had exited Stage 1. In this arrangement, the stainless-steel tubing acted as a preliminary heat exchanger, so that the ethane it contained was heated by the ambient hot effluent. When the ethane reached the distal outlet of the tubing, it passed into the graphite cracking chamber, wherein it initially passed from distal to proximal peripherally within the chamber. At the proximal end of the graphite cracking chamber the ethane encountered a graphite cap, which redirected its flow so that it passed from proximal to distal centrally in a collecting cylinder within the chamber, to emerge from the graphite cracking chamber and flow out through a designated outlet. The path followed by the ethane within the graphite cracking chamber was substantially the path shown schematically in FIGS. 15A and 15B. The flow of ethane within graphite cracking chamber allowed the heat from the hot Stage 1 effluent to be transferred to the ethane. Substantial heat transfer occurred when the ethane encountered the graphite cap at the proximal end of the chamber because the graphite cap was exposed to the hottest portion of the hot effluent exhaust stream. Heating the graphite cap with the hot effluent exhaust stream resulted in heat transfer from the graphite cap to the ethane that passed by it at the proximal end of the graphite cracking chamber. This heat transfer from the graphite cap to the ethane caused it to “crack” into ethylene and acetylene, predominately ethylene. Further, by distributing the heat evenly to the ethane, the graphite cap resulted in improved selectivity for ethylene over other cracking products (here, acetylene). While ethane was used in this Example, the thermal mediator subsystem disclosed herein can be used for any hydrocarbon gas.

In this Example, Stage 1 conditions of 7 SLPM CO₂, 7 SLPM CH₄, and 3150 W of microwave power were used; in Stage 2, 8 SLPM of ethane was used as the reaction target. The conversions for the overall system were 97.1% for CO₂, 93.6% for CH₄, and 43.7% for ethane. The production rates for the overall system were 13.2 SLPM CO, 15.7 SLPM H₂, 2.43 SLPM ethylene, and 0.23 SLPM acetylene.

### EQUIVALENTS

Unless otherwise indicated, all numbers expressing reaction conditions, quantities, amounts, ranges and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

While this invention has been particularly shown and described with references to preferred embodiments thereof, it will be understood by those skilled in the art that various changes in form and details may be made therein without departing from the scope of the invention encompassed by the appended claims.

1. A method for producing a gaseous outflow stream comprising chemical products and thermal energy, comprising:
providing a first reactant stream comprising CO₂ and a second reactant stream comprising a hydrocarbon reactant;
providing a plasma reactor equipped with a source of microwave energy for forming a non-thermal plasma;
mixing the first reactant stream and the second reactant stream to form a feedgas mixture;
directing the feedgas mixture to encounter the microwave energy in the plasma reactor, wherein the microwave energy energizes the feedgas mixture to form the non-thermal plasma, thereby producing the thermal energy and transforming the feedgas mixture in the non-thermal plasma into a product mixture comprising the chemical products; and
directing the product mixture and the thermal energy to exit the plasma reactor, thereby forming the gaseous outflow stream comprising the chemical products and the thermal energy.

2. The method of claim 1, wherein the chemical products comprise CO and H₂.

3. The method of claim 1, wherein the hydrocarbon reactant comprises CH₄.

4. The method of claim 1, wherein the hydrocarbon reactant consists essentially of CH₄.

5. The method of claim 4, wherein the hydrocarbon reactant is derived from a biogas.

6. The method of claim 1, wherein the feedgas mixture further comprises an auxiliary reactant.

7. The method of claim 1, wherein the step of mixing the first reactant stream and the second reactant stream to form the feedgas mixture takes place outside the plasma reactor prior to the step of directing the feedgas mixture to encounter the microwave energy in the plasma reactor.

8. The method of claim 1, further comprising the step of flowing the gaseous outflow stream through an outflow tract in fluid communication with the plasma reactor, wherein the outflow tract comprises a shape-forming structure.

9. The method of claim 8, wherein the shape-forming structure is a converging-diverging nozzle.

10. A method of producing one or more derivative products, comprising:
forming a gaseous outflow stream by the method of claim 1;
flowing the gaseous outflow stream through an outflow tract in fluid communication with the plasma reactor to enter a derivative reaction zone; and
producing a derivative reaction in the derivative reaction zone using the chemical products, or the thermal energy, or a combination thereof, to form the one or more derivative products.

11. The method of claim 10, wherein the step of producing the derivative reaction comprises adding additive particles to the gaseous outflow stream.

12. The method of claim 11, wherein the additive particles are non-carbon particles, and the derivative reaction forms composite particles.

13. The method of claim 10, wherein the derivative reaction is produced using the chemical products.

14. The method of claim 13, wherein the chemical products comprise carbon solids.

15. The method of claim 14, wherein the carbon solids provide seeds for formation of carbon solids or further growth of carbon solids.

16. The method of claim 13, wherein the derivative reaction is produced by directing a secondary reactant to enter the derivative reaction zone to react therein with the chemical products.

17. The method of claim 10, wherein the derivative reaction is produced using the thermal energy, the method comprising directing a reaction target to enter the derivative reaction zone and exposing the reaction target therein to the thermal energy.

18. The method of claim 17, wherein the reaction target is a hydrocarbon reactant.

19. The method of claim 18, wherein the derivative reaction is a pyrolysis reaction.

20. The method of claim 18, wherein the hydrocarbon reactant is selected from the group consisting of methane, ethane, propane, ethylene, and acetylene.

21. The method of claim 20, wherein the hydrocarbon reactant is ethane.

22. The method of claim 18, wherein the hydrocarbon reactant is a mixture of a first hydrocarbon gas and a second hydrocarbon gas.

23. The method of claim 22, wherein the first hydrocarbon gas and the second hydrocarbon gas are both selected from the group consisting of methane, ethane, propane, ethylene, and acetylene.

24. The method of claim 17, wherein the reaction target comprises a natural polymer derived from biomass.

25. The method of claim 24, wherein the natural polymer derived from biomass is pyrolyzed to produce biochar.

26. The method of claim 25, wherein the biochar is further processed to produce activated carbon.

27. The method of claim 24, wherein the natural polymer is lignin or hemicellulose.

28. The method of claim 17, wherein the reaction target comprises a synthetic hydrocarbon-derived polymer or a fluorinated molecule.

29. The method of claim 17, wherein the reaction target comprises one or more petroleum residua materials.

30. The method of claim 29, wherein the one or more petroleum residua materials are derived from crude oil bottoms or waste oil.

31. The method of claim 30, wherein the one or more petroleum residua materials comprise bitumen.

32. The method of claim 17, wherein the one or more derivative products comprises carbon solids.

33. The method of claim 10, wherein the one or more derivative products comprise a plurality of different derivative products.

34. The method of claim 33, further comprising processing the plurality of different derivative products to produce a selected product mix.

35. The method of claim 34, wherein the selected product mix forms a sustainable aviation fuel.

36. The method of claim 17, wherein the reaction target is sequestered within a self-contained heating chamber within a thermal mediator subsystem within the derivative reaction zone, wherein the reaction target is isolated from the chemical products, and wherein the reaction target is exposed to the thermal energy, thereby producing the derivative reaction.

37. A method of producing a tertiary reaction, comprising:
producing the one or more derivative products according to the method of claim 10, and processing the one or more derivative products to react with each other or to react with a tertiary reactant, thereby producing the tertiary reaction.

38. (canceled)

39. A plasma-based system for converting a hydrocarbon reactant and CO₂ into a gaseous outflow stream comprising chemical products and thermal energy, the system comprising:
a feedgas subsystem delivering the hydrocarbon reactant and the CO₂ into a plasma reactor, wherein the plasma reactor has a proximal end and a distal end and a plasma reaction zone therebetween, wherein the hydrocarbon reactant and the CO₂ are directed to follow a flow path to enter the plasma reactor and to pass therethrough, and wherein the hydrocarbon reactant and the CO₂ enter the plasma reaction zone in a mixed state;
a source of microwave energy, wherein the source delivers the microwave energy to the plasma reaction zone as the hydrocarbon reactant and the CO₂ pass therethrough in the mixed state, to produce a non-thermal plasma from the mixed state of the hydrocarbon reactant and the CO₂, and wherein the non-thermal plasma converts the hydrocarbon reactant and the CO₂ into the chemical products and further produces the thermal energy; and
an outflow tract at the distal end of the reaction chamber and in fluid communication therewith, wherein the chemical products and the thermal energy exit the reaction zone as the gaseous outflow stream, and the gaseous outflow stream enters the outflow tract to be removed from the plasma reactor.

40-49. (canceled)

50. A modular system for converting a hydrocarbon reactant and CO₂ into a gaseous outflow stream comprising chemical products and thermal energy, wherein the modular system comprises one or more of the plasma-based systems of claim 39 operatively connected with a control system, wherein the control system controls at least one functional parameter of the one or more plasma-based systems.

51-58. (canceled)

59. A system for producing a derivative reaction, comprising:
the system of claim 39;
a derivative reaction zone in fluid communication with the outflow tract, wherein a shape-forming structure directs the gaseous outflow stream into a derivative reaction zone; and
an injector for delivering one or more external reactants into the outflow tract or into the derivative reaction zone, wherein an interaction between external reactants and at least one of the chemical products and the thermal energy produces the derivative reaction.

60-64. (canceled)
